(19) United States
(12) Patent Application Publication
(10) Pub. No.: US 2023/0282203 A1
(43) Pub. Date: Sep. 7, 2023

(54) INFORMATION PROCESSING APPARATUS AND INFORMATION PROCESSING METHOD

(71) Applicant: SONY GROUP CORPORATION, TOKYO (JP)

(72) Inventor: FUMINORI HOMMA, TOKYO (JP)

(21) Appl. No.: 17/907,600

(22) PCT Filed: Mar. 30, 2021
(86) PCT No.: PCT/JP2021/013606

§ 371 Date: Sep. 28, 2022

(30) Foreign Application Priority Data
Apr. 6, 2020 (JP) 2020-068467

(51) Int. Cl. G10L 15/02; G10L 25/63; G10L 15/26

(52) U.S. Cl. CPC G10L 15/02; G10L 15/26; G10L 25/63

(57) ABSTRACT

More fulfilling service can be provided. An information processing apparatus (10) according to an embodiment includes: an acquisition unit (111) that acquires speech logs of speeches of a plurality of speakers; and an extraction unit (1128) that extracts information for generating a classifier that estimates a speech intention of each of the speeches based on the speech logs acquired by the acquisition unit (111) and a response manual indicating an example of a response for each of the speeches.

### FIELD

The present disclosure relates to an information processing apparatus and an information processing method.

### BACKGROUND

Techniques for supporting a speech of a speaker based on an enormous speech log have become common. For example, techniques for supporting a speech of a speaker so as to induce a more active speech by grasping the situation of speeches of a plurality of speakers that change from moment to moment have become common.

### CITATION LIST

### Patent Literature

Patent Literature 1: JP 2013-58221 A

### SUMMARY

### Technical Problem

Unfortunately, in conventional techniques, sufficiently supporting a speech of a speaker is difficult when the content of the speech fails to be subjected to appropriate language analysis. This may lead to a case where it is difficult to provide fulfilling service to the speaker.

Thus, the present disclosure proposes a new and improved information processing apparatus and information processing method capable of providing more fulfilling service.

### Solution to Problem

According to the present disclosure, an information processing apparatus includes: an acquisition unit that acquires speech logs of speeches of a plurality of speakers; and an extraction unit that extracts information for generating a classifier that estimates a speech intention of each of the speeches based on the speech logs acquired by the acquisition unit and a response manual indicating an example of a response for each of the speeches.

### BRIEF DESCRIPTION OF DRAWINGS

FIG. 1 illustrates a configuration example of an information processing system according to an embodiment.

FIG. 2 outlines the function of the information processing system according to the embodiment.

FIG. 3 illustrates one example of a speech log and a response manual according to the embodiment.

FIG. 4 illustrates one example of noise according to the embodiment.

FIG. 5 is a block diagram illustrating a configuration example of the information processing system according to the embodiment.

FIG. 6 illustrates one example of a classifier for feature amount conversion according to the embodiment.

FIG. 7 illustrates one example of text information of the feature amount conversion according to the embodiment.

FIG. 8 illustrates one example of estimation of a speech buffer according to the embodiment.

FIG. 9 illustrates one example of annotation imparting according to the embodiment.

FIG. 10 illustrates one example of generation and processing of a classifier according to the embodiment.

FIG. 11 illustrates one example of a speech log and a response manual according to the embodiment.

FIG. 12 illustrates one example of output information according to the embodiment.

FIG. 13 illustrates one example of a storage unit according to the embodiment.

FIG. 14 illustrates one example of the storage unit according to the embodiment.

FIG. 15 illustrates one example of RNN processing according to the embodiment.

FIG. 16 illustrates one example of the RNN processing according to the embodiment.

FIG. 17 illustrates one example of the storage unit according to the embodiment.

FIG. 18 is a flowchart illustrating the flow of processing in an information processing apparatus according to the embodiment.

FIG. 19 is a flowchart illustrating the flow of the processing in the information processing apparatus according to the embodiment.

FIG. 20 is a flowchart illustrating the flow of the processing in the information processing apparatus according to the embodiment.

FIG. 21 illustrates one example of variations of processing according to the embodiment.

FIG. 22 illustrates one example of an ASR result according to the embodiment.

FIG. 23 illustrates one example of estimation of an operator speech according to the embodiment.

FIG. 24 illustrates one example of a data set according to the embodiment.

FIG. 25 illustrates one example of estimation processing according to the embodiment.

FIG. 26 illustrates one example of estimation of a user speech according to the embodiment.

FIG. 27 illustrates one example of a user response according to the embodiment.

FIG. 28 illustrates one example of applications according to the embodiment.

FIG. 29 illustrates one example of the applications according to the embodiment.

FIG. 30 illustrates one example of the applications according to the embodiment.

FIG. 31 illustrates one example of the applications according to the embodiment.

FIG. 32 illustrates one example of the applications according to the embodiment.

FIG. 33 is a hardware configuration diagram illustrating one example of a computer that implements the function of the information processing apparatus.

### DESCRIPTION OF EMBODIMENTS

A preferred embodiment of the present disclosure will be described in detail below with reference to the accompanying drawings. Note that, in the present specification and the drawings, components having substantially the same functional configuration are denoted by the same reference signs, and redundant description thereof will be omitted.

Note that the description will be given in the following order.
1. One Embodiment of Present Disclosure
1.1. Introduction
1.2. Configuration of Information Processing System
2. Function of Information Processing System
2.1. Outline of Function
2.2. Functional Configuration Example
2.3. Processing of Information Processing System
2.4. Variations of Processing
3. Applications
4. Hardware Configuration Example
5. Conclusion

### 1. One Embodiment of Present Disclosure

### <1.1. Introduction>

When a speaker accustomed to giving a speech and a speaker unaccustomed to giving a speech speak with each other, support of speech may be important. For example, a case where an operator of a call center and the like and an end user (user) who uses service operated by the operator speak with each other applies to the case. Since being accustomed to giving a speech, the operator often accurately speaks. In contrast, since the user speaks while organizing the contents of the speech, the speech of the user may include an unclear phrase (noise) associated with falter, speech fluctuation, and the like.

In order to support a speech of the speaker, estimating a speech intention from the speech may be important. In this case, the speech may be converted into language information (text information). When the speech of the user includes noise, however, the converted text information may fail to be subjected to appropriate language analysis. Furthermore, similarly to when the user speaks interrupting a speech of the operator or when the user speaks at intervals, appropriate language analysis processing may fail to be performed. Furthermore, similarly to when the user speaks while dividing one sentence into a plurality of sentences and when the user speaks while combining a plurality of sentences in one speech, appropriate language analysis may fail to be performed.

When appropriate language analysis for the speech contents cannot be performed, sufficient support of a speech of the speaker may be difficult. Therefore, providing more fulfilling service to a speaker has been difficult in some cases.

Thus, the present disclosure proposes a new and improved information processing apparatus and information processing method capable of providing more fulfilling service.

### <1.2. Configuration of Information Processing System>

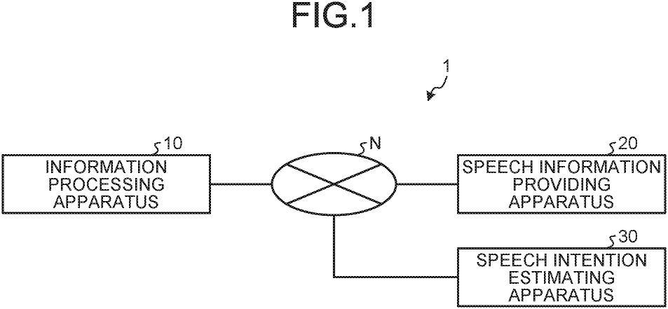

The configuration of an information processing system 1 according to an embodiment will be described. FIG. 1 illustrates a configuration example of the information processing system 1. As illustrated in FIG. 1, the information processing system 1 includes an information processing apparatus 10, a speech information providing apparatus 20, and a speech intention estimating apparatus 30. Various apparatuses can be connected to the information processing apparatus 10. For example, the speech information providing apparatus 20 and the speech intention estimating apparatus 30 are connected to the information processing apparatus 10, and information cooperation is performed between the apparatuses. The information processing apparatus 10, the speech information providing apparatus 20, and the speech intention estimating apparatus 30 are connected to an information communication network by wireless or wired communication so as to mutually perform information/data communication and operate in cooperation. The information communication network may include the Internet, a home network, an Internet of Things (IoT) network, a peer-to-peer (P2P) network, a proximity communication mesh network, and the like. In the wireless communication, for example, Wi-Fi, Bluetooth (registered trademark), or a technique based on a mobile communication standard such as 4G and 5G can be used. In the wired communication, a power line communication technique such as Ethernet (registered trademark) and power line communications (PLC) can be used. Note that the information processing apparatus 10, the speech information providing apparatus 20, and the speech intention estimating apparatus 30 may be separately provided as a plurality of computer hardware apparatuses so-called on a premise, an edge server, or a cloud. Functions of a plurality of optional apparatuses among the information processing apparatus 10, the speech information providing apparatus 20, and the speech intention estimating apparatus 30 may be provided by the same apparatus. Moreover, the user can mutually perform information/data communication with the information processing apparatus 10, the speech information providing apparatus 20, and the speech intention estimating apparatus 30 via a user interface (including GUI) and software (including computer program (hereinafter, also referred to as program)), which operate on a terminal apparatus (personal device such as personal computer (PC) and smartphone including display serving as information display apparatus, voice, and keyboard input) (not illustrated).

### (1) Information Processing Apparatus 10

The information processing apparatus 10 performs processing of extracting information for generating a classifier that estimates a speech intention of a speaker. Specifically, the information processing apparatus 10 acquires speech logs of speeches of a plurality of speakers. Then, the information processing apparatus 10 extracts the information for generating a classifier that estimates a speech intention based on the acquired speech logs and a response manual indicating an example of a response for the speech. Note that the classifier belonging to the present invention can be generated by performing training using learning data using a technique of machine learning, and provides a function of artificial intelligence (such as learning function and estimation (inference) function). For example, deep learning can be used as the technique of machine learning. In this case, the classifier can include a deep neural network (DNN). Furthermore, particularly, a recurrent neural network (RNN) is preferably used as the deep neural network.

Furthermore, the information processing apparatus 10 also has a function of controlling the overall operation of the information processing system 1. For example, the information processing apparatus 10 controls the overall operation of the information processing system 1 based on information in cooperation between the apparatuses. Specifically, the information processing apparatus 10 extracts the information for generating a classifier that estimates a speech intention based on information received from the speech information providing apparatus 20. When the classifier includes a deep neural network, the information for generation is learning data.

The information processing apparatus 10 is implemented by a PC, a server, and the like. Note that the information processing apparatus 10 is not limited to the PC, the server, and the like. For example, the information processing apparatus 10 may be a computer hardware apparatus such as a PC and a server in which a function as the information processing apparatus 10 is mounted as an application.

### Speech Information Providing Apparatus 20

The speech information providing apparatus 20 is an information processing apparatus that provides information regarding speech information to the information processing apparatus 10.

The speech information providing apparatus 20 is implemented by a PC, a server, and the like. Note that the speech information providing apparatus 20 is not limited to the PC, the server, and the like. For example, the speech information providing apparatus 20 may be a computer hardware apparatus such as a PC and a server in which a function as the speech information providing apparatus 20 is mounted as an application.

### Speech Intention Estimating Apparatus 30

The speech intention estimating apparatus 30 is an information processing apparatus that estimates a speech intention based on information received from the information processing apparatus 10.

The speech intention estimating apparatus 30 is implemented by a PC, a server, and the like. Note that the speech intention estimating apparatus 30 is not limited to the PC, the server, and the like. For example, the speech intention estimating apparatus 30 may be a computer hardware apparatus such as a PC and a server in which a function as the speech intention estimating apparatus 30 is mounted as an application. Note that, as described above, in the information processing system 1, the information processing apparatus 10, the speech information providing apparatus 20, and the speech intention estimating apparatus 30 are connected to an information communication network by wireless or wired communication so as to mutually perform information/data communication and operate in cooperation. The information processing apparatus 10, the speech information providing apparatus 20, and the speech intention estimating apparatus 30 may be separately provided as a plurality of computer hardware apparatuses so-called on a premise, an edge server, or a cloud. Functions of a plurality of optional apparatuses among the information processing apparatus 10, the speech information providing apparatus 20, and the speech intention estimating apparatus 30 may be provided as the same apparatus. The user can mutually perform information/data communication with the information processing apparatus 10, the speech information providing apparatus 20, and the speech intention estimating apparatus 30 via a user interface (including GUI) and software, which operate on a terminal apparatus (personal device such as PC and smartphone including display serving as information display apparatus, voice, and keyboard input) (not illustrated).

### 2. Function of Information Processing System

The configuration of the information processing system 1 has been described above. Subsequently, the function of the information processing system 1 will be described.

In the embodiment, a first speaker will be described as an “operator” and a second speaker will be described as a “user” as appropriate below. Note that the user uses service operated by the operator.

A speech log according to the embodiment is hereinafter text information obtained by converting a speech into text.

In the embodiment, a plurality of speech logs will be hereinafter collectively referred to as a “speech buffer” as appropriate. Therefore, in the embodiment, the speech buffer will be hereinafter referred to as a “speech log” as appropriate.

In the embodiment, the response manual and the speech log in a case where the response manual is used will be hereinafter collectively referred to as “speech information” as appropriate.

In the embodiment, a classifier that outputs data for estimating a speech intention of the user will be hereinafter referred to as a “second classifier” as appropriate. A classifier that outputs a speech buffer extracted for generating the “second classifier” and a corresponding speech intention will be referred to as a “first classifier”.

A speech according to the embodiment includes not only a voice speech but dialogue using text information such as a chat.

### <2.1. Outline of Function>

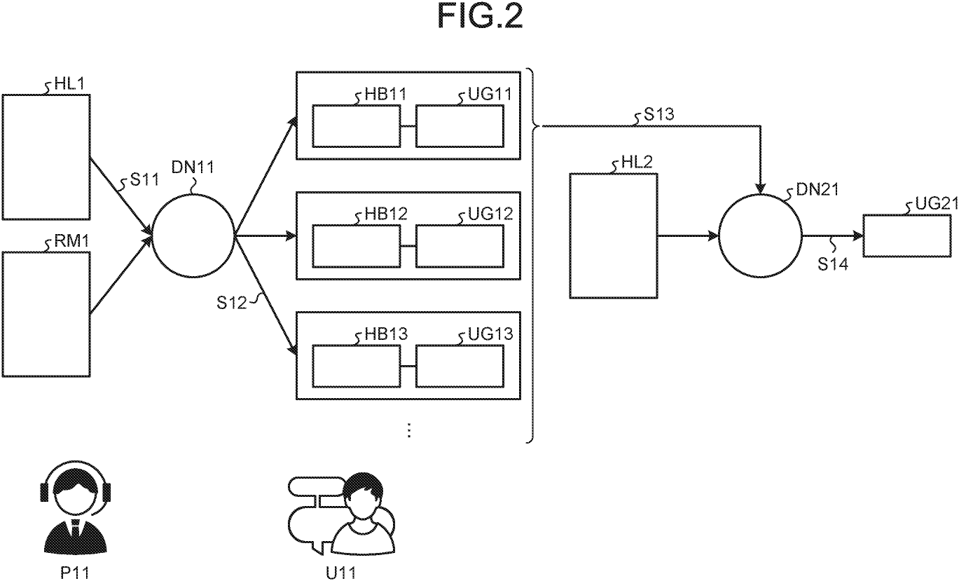

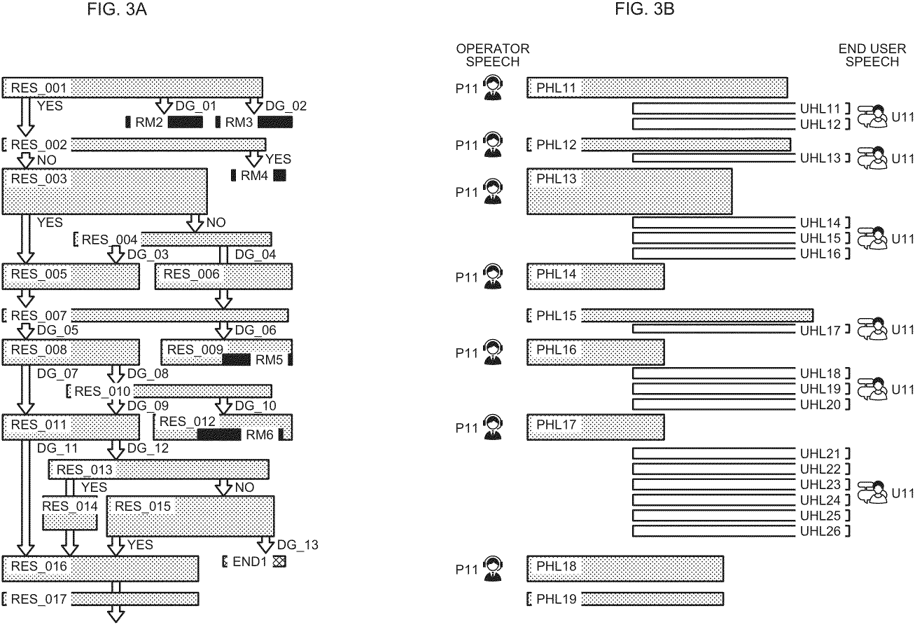

FIG. 2 outlines the function of the information processing system 1 according to the embodiment. Specifically, the information processing system 1 generates the first classifier and the second classifier by learning. The information processing system 1 inputs a response manual RM1 to the first classifier DN11 as teacher data (S11) and performs learning, thereby generating a learned first classifier DN11. The learned first classifier DN11 outputs speech buffers HB11 to HB13 and speech intentions (speech intentions UG11 to UG13) as “annotations” corresponding to the speech buffers by inputting a speech log HL1 (S12). The speech log HL1 includes a speech log of an operator P11 (hereinafter, appropriately referred to as “operator speech”) and a speech log of a user U11 (hereinafter, appropriately referred to as “user speech”). Details of the speech log HL1 and the response manual RM1 will be described later with reference to FIG. 3. Next, the speech buffers and the speech intentions output from the learned first classifier DN11 are extracted, and input to a second classifier DN21 as teacher data to be learned (S13), whereby a learned second classifier DN21 is generated. The information processing system 1 can estimate a speech intention UG21 by inputting any speech log HL2 to the generated second classifier DN21 as input information (S14). The first classifier and the second classifier can include a predetermined deep neural network.

FIG. 3 illustrates one example of the speech log HL1 and the response manual RM1. FIG. 3(A) illustrates one example of the response manual RM1. Manuals RES001 to RES017 are lines preliminarily described in a manual in order to support speeches of the operator P11. User responses DG01 to DG13 are examples of responses of the user U11 to the lines of the operator P11. The user response DG is also a speech intention UG. For example, the user response DG01 is an example of a response of the user U11 at the time when the operator P11 reads the manual RES001. “YES” and “NO” are response examples of a YES response and a NO response of the user U11 to a line of the operator P11. Response manuals RM2 to RM6 are response manuals of transition destinations in a case where transition is performed from the response manual RM1 to another response manual. For example, when the user U11 gives a response of the user response DG01 at the time when the operator P11 reads the manual RES001, the transition to the response manual RM2 is performed. A speech end END1 is an end of speeches between the operator P11 and the user U11. For example, when the user U11 gives a response of the user response DG13 at the time when the operator P11 reads the manual RES015, the response manual RM1 ends.

FIG. 3(B) illustrates one example of the speech log HL1. The operator speeches PHL11 to PHL19 indicate speech logs of actual speeches of the operator P11. Since the operator P11 is accustomed to giving a speech, the speech of the operator P11 may have less noise such as speech fluctuation and falter. In this case, the operator speeches PHL11 to PHL19 have less noise. In contrast, since the user U11 is unaccustomed to giving a speech, the speech of the user U11 may have much noise such as speech fluctuation and falter. In this case, user speeches UHL11 to UHL16 have much noise. Furthermore, since the speech log HL1 is text information written via automatic speech recognition (ASR), noise is uncorrected. Therefore, text information may fail to be clearly cut out based on appropriate context and the like.

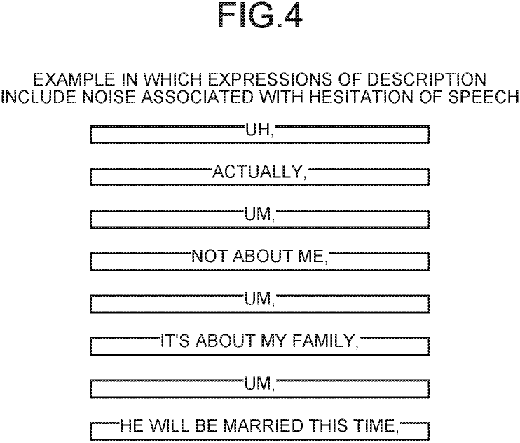

FIG. 4 illustrates examples of noise in a user speech. The user speech in FIG. 4 is a speech log used for illustrating the situation of the user U11 at the beginning of the speech. As illustrated in FIG. 4, a user speech may include much noise such as “uh” and “um”, the speech intention may fail to be accurately understood.

### <2.2. Functional Configuration Example>

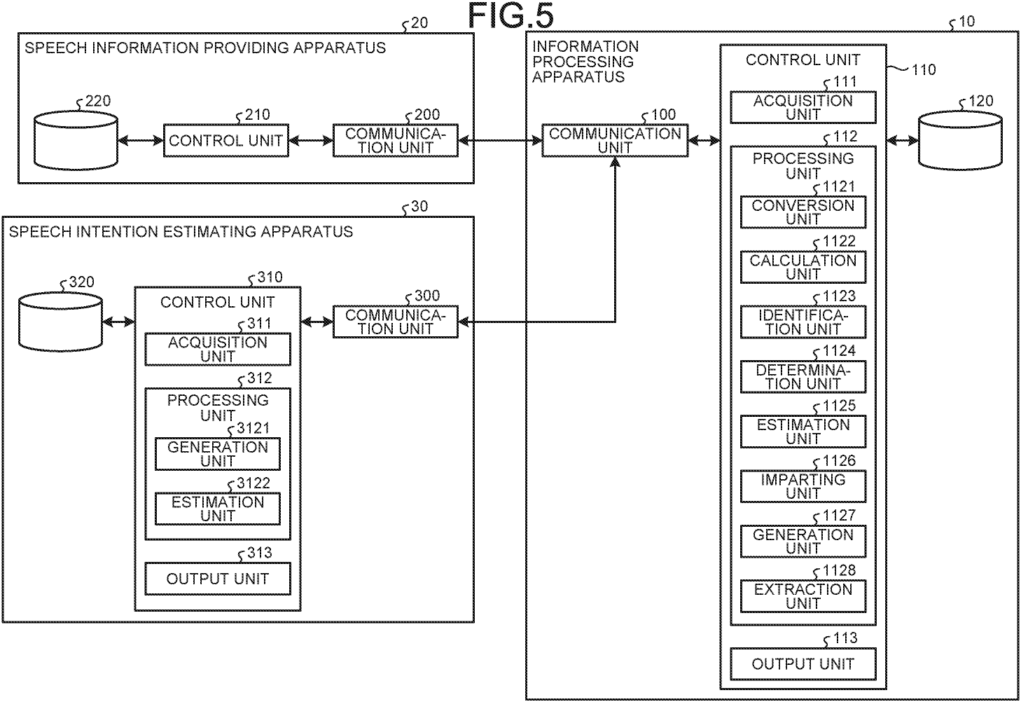

FIG. 5 is a block diagram illustrating a functional configuration example of the information processing system 1 according to the embodiment.

### (1) Information Processing Apparatus 10

As illustrated in FIG. 5, the information processing apparatus 10 includes a communication unit 100, a control unit 110, and a storage unit 120. Note that the information processing apparatus 10 includes at least the control unit 110.

### 1) Communication Unit 100

The communication unit 100 has a function of communicating with an external apparatus. For example, in the communication with the external apparatus, the communication unit 100 outputs information received from the external apparatus to the control unit 110. Specifically, the communication unit 100 outputs information received from the speech information providing apparatus 20 to the control unit 110. For example, the communication unit 100 outputs information regarding the speech information to the control unit 110.

In the communication with the external apparatus, the communication unit 100 transmits information input from the control unit 110 to the external apparatus. Specifically, the communication unit 100 transmits information regarding acquisition of information regarding speech information input from the control unit 110 to the speech information providing apparatus 20. The communication unit 100 can include a hardware circuit (such as communication processor), and perform processing by using a computer program that operates on the hardware circuit or another processing apparatus (such as CPU) that controls the hardware circuit.

### 2) Control Unit 110

The control unit 110 has a function of controlling the operation of the information processing apparatus 10. For example, the control unit 110 performs processing of extracting information for generating the second classifier that estimates a speech intention.

In order to implement the above-described functions, the control unit 110 includes an acquisition unit 111, a processing unit 112, and an output unit 113 as illustrated in FIG. 5. The control unit 110 may include a processor such as a CPU, and may read software (computer program) for implementing each function of the acquisition unit 111, the processing unit 112, and the output unit 113 from the storage unit 120 to perform processing. Furthermore, one or more of the acquisition unit 111, the processing unit 112, and the output unit 113 can include a hardware circuit (such as processor) different from the control unit 110, and can be controlled by a computer program that operates on the different hardware circuit or the control unit 110.

### • Acquisition Unit 111

The acquisition unit 111 has a function of acquiring information regarding speech information. The acquisition unit 111 acquires, for example, information regarding speech information transmitted from the speech information providing apparatus 20 via the communication unit 100. For example, the acquisition unit 111 acquires information regarding speech logs given by a plurality of speakers including an operator and a user.

The acquisition unit 111 acquires, for example, information regarding a response manual. For example, the acquisition unit 111 acquires information regarding a response manual used by the operator at the time of giving the speech logs.

### • Processing Unit 112

The processing unit 112 has a function for controlling processing of the information processing apparatus 10. As illustrated in FIG. 5, the processing unit 112 includes a conversion unit 1121, a calculation unit 1122, an identification unit 1123, a determination unit 1124, an estimation unit 1125, an imparting unit 1126, a generation unit 1127, and an extraction unit 1128. The conversion unit 1121, the calculation unit 1122, the identification unit 1123, the determination unit 1124, the estimation unit 1125, the imparting unit 1126, the generation unit 1127, and the extraction unit 1128 of the processing unit 112 may be independent modules of a computer program, or may be configured as one integrated module of a computer program of a plurality of functions.

### • Conversion Unit 1121

The conversion unit 1121 has a function of converting any text information into a feature amount (e.g., vector). For example, the conversion unit 1121 converts a speech log and a response manual acquired by the acquisition unit 111 into feature amounts. For example, the conversion unit 1121 performs the conversion into a feature amount by performing language analysis on the text information based on language analysis processing, such as writing with space between words, using a vocabulary dictionary and the like. Furthermore, the conversion unit 1121 may convert the text information subjected to the language analysis into a sequence based on a predetermined aspect or original text information (e.g., sentence).

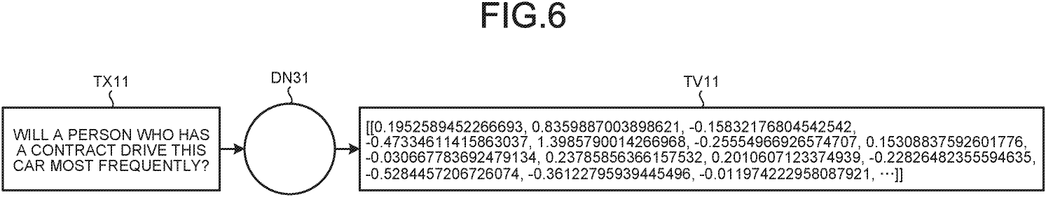

FIG. 6 illustrates one example of a classifier that converts any text information into a feature amount. In FIG. 6, when text information TX11 is input to a classifier DN31, a feature amount TV11 is output. The feature amount TV11 is obtained by vectorizing text information. For example, the conversion unit 1121 converts any text information into a feature amount by using the classifier DN31.

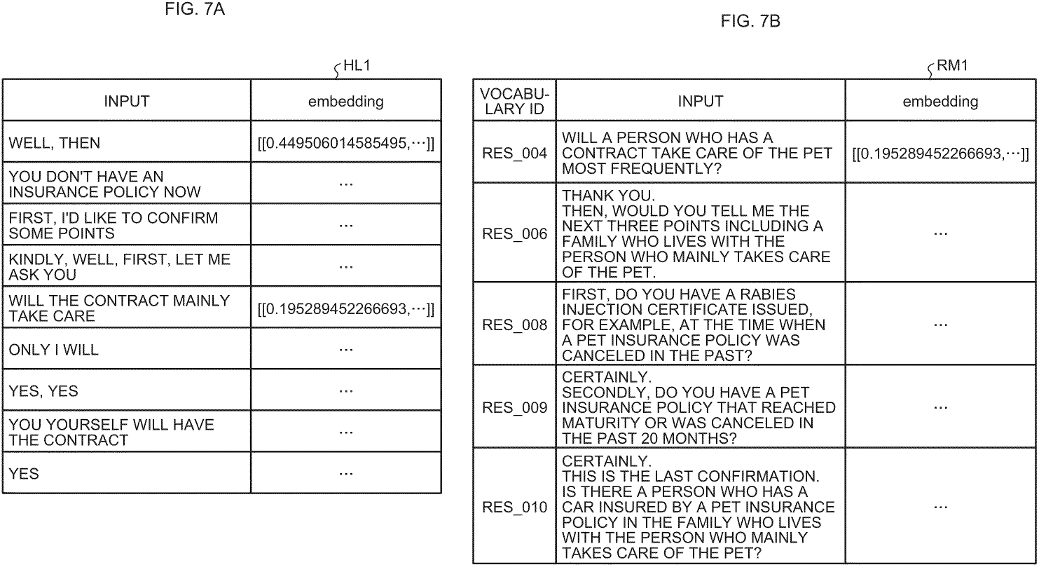

FIG. 7 illustrates one example of the correspondence relation between input information input to the classifier DN31 and output information output from the classifier DN31. FIG. 7(A) illustrates a correspondence relation in a case where the input information is the speech log HL1. FIG. 7(B) illustrates a correspondence relation in a case where the input information is the response manual RM1. Note that closer feature amounts indicate closer speech intentions. FIG. 7 indicates that a speech log included in the response manual RM1 closest to the speech log of “Will the contractor mainly take care?” included in the speech log HL11 corresponds to “Will a person who has a contract take care of the pet the most frequently?”.

### • Calculation Unit 1122

The calculation unit 1122 has a function of calculating the similarity between feature amounts converted by the conversion unit 1121. For example, the calculation unit 1122 calculates the similarity between a feature amount of a speech log and a feature amount of a response manual. For example, the calculation unit 1122 calculates the similarity between the feature amounts by comparing cosine distances of the feature amounts. Note that higher similarities indicate closer feature amounts.

The calculation unit 1122 calculates a loss using a loss function. For example, the calculation unit 1122 calculates losses of input information input to a predetermined classifier and output information output therefrom. Furthermore, the calculation unit 1122 performs processing using error backpropagation.

### • Identification Unit 1123

The identification unit 1123 has a function of identifying text information having a close feature amount based on the similarity calculated by the calculation unit 1122. For example, the identification unit 1123 identifies text information having a similarity of equal to or greater than a predetermined threshold. For example, the identification unit 1123 identifies text information having the highest similarity. Furthermore, for example, the identification unit 1123 identifies text information having a feature amount close to a feature amount of any text information converted by the conversion unit 1121. For example, the identification unit 1123 identifies a response manual having a feature amount close to the feature amount of the speech log. Note that an operator speech corresponding to a response manual identified by the identification unit 1123 will be hereinafter appropriately referred to as an “anchor response”.

### • Determination Unit 1124

The determination unit 1124 has a function of determining an anchor response. Specifically, the determination unit 1124 determines whether or not there is a response manual whose similarity to any speech log is equal to or greater than a predetermined threshold based on a similarity calculated by the calculation unit 1122. When determining that there is no response manual whose similarity to a speech log is equal to or greater than a predetermined threshold, the determination unit 1124 determines that the speech log is other than the anchor response. Then, the determination unit 1124 determines the speech log to be a speech buffer indicating a speech log other than the anchor response. The speech buffer is a single or a plurality of speech logs included between anchor responses. Note that the speech buffer may include not only a user speech but an operator speech. The speech buffer may be interpreted as one speech log including a single or a plurality of speech logs included between anchor responses. Furthermore, when determining that there is a response manual whose similarity to a speech log is equal to or greater than a predetermined threshold, the determination unit 1124 determines that the speech log to be an anchor response. Furthermore, the determination unit 1124 may add a label of a speech buffer and an anchor response to the determined speech log.

The determination unit 1124 determines whether or not text information satisfying a predetermined condition has been converted into a sequence based on a predetermined aspect. For example, the determination unit 1124 determines whether or not all the data of the text information subjected to language analysis has been converted into a sequence based on a predetermined aspect.

The determination unit 1124 determines whether or not the loss calculated by the calculation unit 1122 satisfies a predetermined condition. For example, the determination unit 1124 determines whether or not the loss based on the loss function is minimized.

### • Estimation Unit 1125

The estimation unit 1125 has a function of estimating a speech buffer. Specifically, the estimation unit 1125 estimates a speech log between anchor responses as a speech buffer. Furthermore, the estimation unit 1125 may estimate an anchor response to be given next by the operator based on the speech log and the response manual.

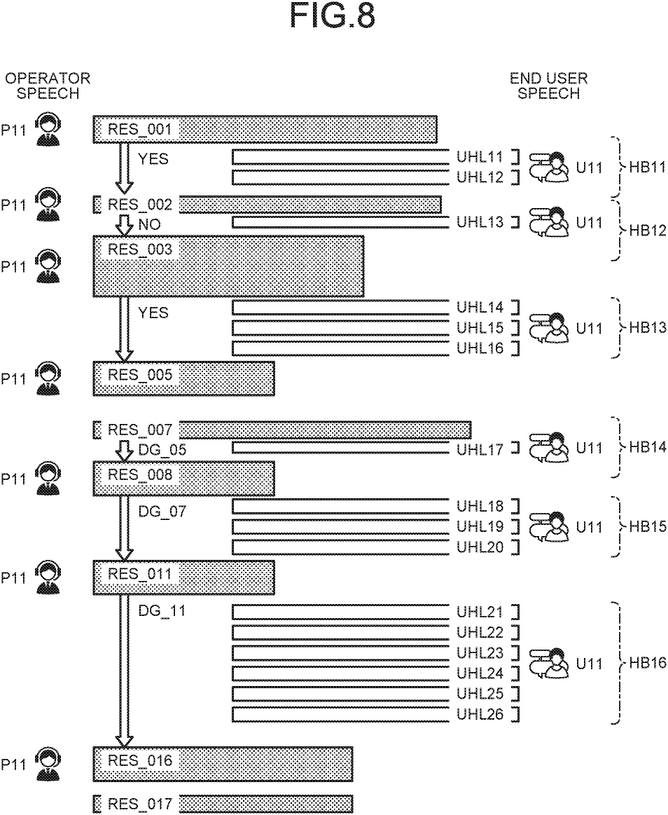

FIG. 8 illustrates one example of estimation of the speech buffer. In FIG. 8, the operator speeches of the operator P11 at the time when the manuals RES001 to RES017 are read are anchor responses. For example, the estimation unit 1125 estimates a speech log included between an operator speech corresponding to the manual RES001 and an operator speech corresponding to the manual RES002 as a speech buffer HB11. Note that the speech buffer HB11 includes user speeches UHL11 to UHL26. Furthermore, a user response DG05 and the like are examples of responses of the user U11 to the lines of the operator P11. Furthermore, “YES” and “NO” are response examples of a YES response and a NO response of the user U11 to a line of the operator P11. Note that the response examples are the speech intentions of the user speeches. For example, the speech intentions of the user speech UHL11 and the user speech UHL12 included in the speech buffer HB11 are “YES” responses.

The estimation unit 1125 may estimate the manual RES017 as the next anchor response of the manual RES016. Specifically, the estimation unit 1125 may estimate the manual RES017 that has not yet been read by the operator P11 as the next anchor response of the manual RES016. Then, the estimation unit 1125 may estimate a speech log before and after the estimated next anchor response as a speech buffer.

### • Imparting Unit 1126

The imparting unit 1126 has a function of imparting a speech intention to the speech buffer as an annotation (e.g., label). Specifically, the imparting unit 1126 imparts an annotation indicating a speech intention to the speech buffer estimated by the estimation unit 1125. For example, the imparting unit 1126 adds an annotation to any speech buffer by inputting and learning a combination (data set) of a speech buffer and an annotation imparted to the speech buffer as teacher data. Furthermore, the imparting unit 1126 may impart an annotation to a speech buffer included in a speech log of any speech information by inputting and learning a combination of extraction information and speech information corresponding to the extraction information as teacher data, for example. Furthermore, the imparting unit 1126 may impart an annotation to a speech buffer based on an anchor response that has not yet been read, for example.

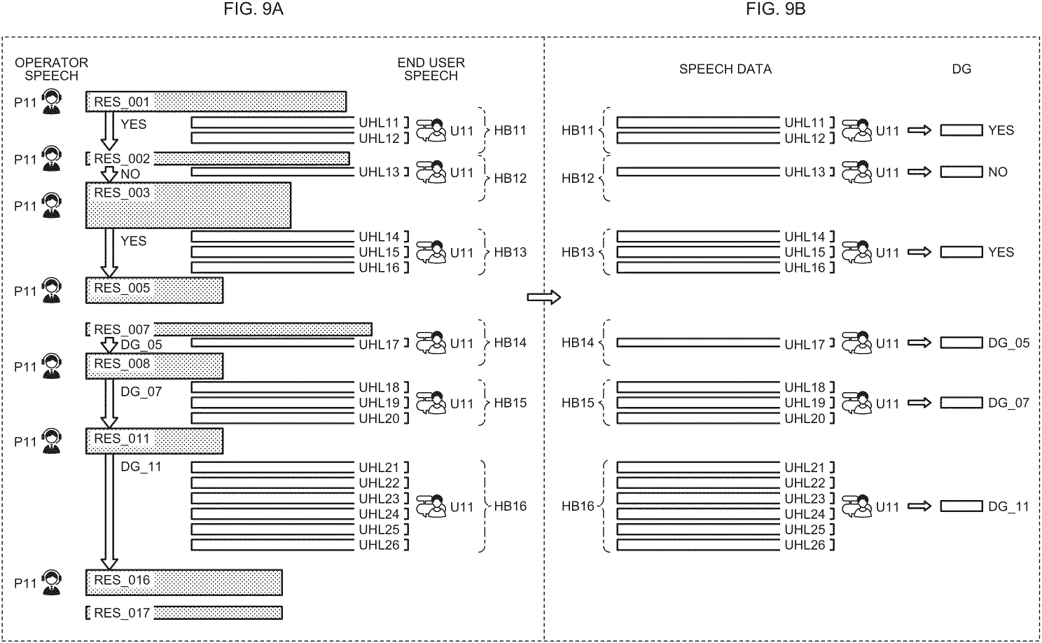

FIG. 9 illustrates one example of annotation imparting. Since FIG. 9(A) is the same as FIG. 8, the description thereof will be omitted. FIG. 9(B) illustrates a combination of a speech buffer obtained by removing an anchor response from the speech log in FIG. 9(A) and a speech intention. For example, in FIG. 9(B), the speech intention corresponding to the speech buffer HB11 is a YES response.

### • Generation Unit 1127

The generation unit 1127 has a function of generating the first classifier based on information regarding a combination of a speech buffer and a speech intention. Specifically, the generation unit 1127 generates the first classifier that imparts an annotation of a speech intention to any speech buffer by inputting and learning a combination of the annotation imparted by the imparting unit 1126 and the speech buffer as teacher data. Furthermore, the generation unit 1127 may generate the first classifier that imparts an annotation of a speech intention to a speech buffer included in a speech log of any speech information by inputting and learning a combination of extraction information and speech information corresponding to the extraction information as teacher data, for example.

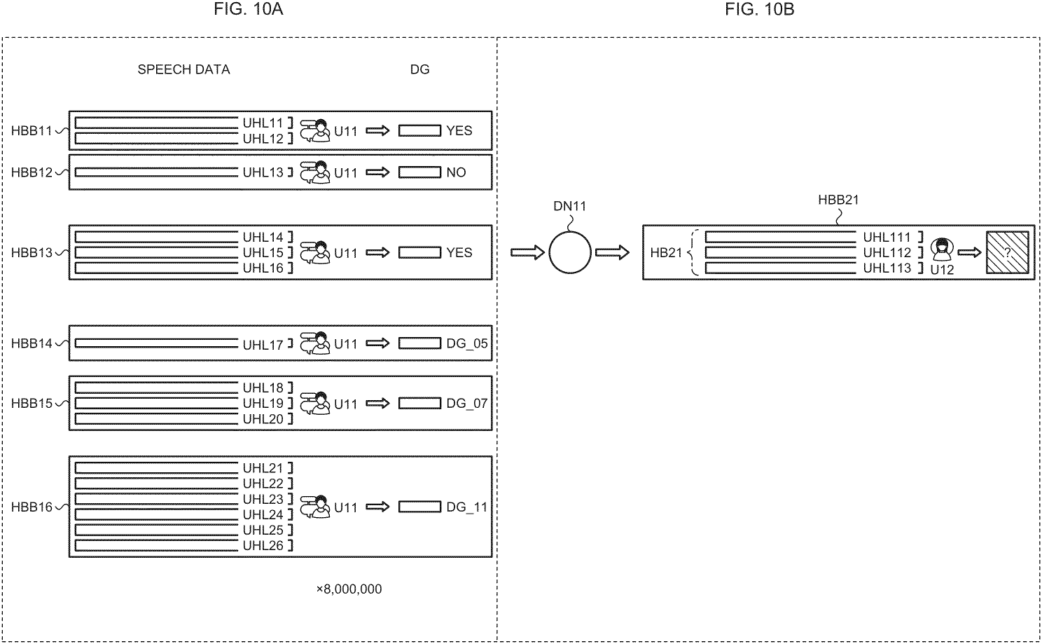

FIG. 10 illustrates one example of generation and processing of the first classifier. FIG. 10(A) illustrates one example of a combination of a speech buffer and a speech intention extracted by the extraction unit 1128. For example, the extraction unit 1128 extracts extraction information HBB11, which is a combination of the speech buffer HB11 and the speech intention “YES”. For example, the generation unit 1127 generates the first classifier DN11 by learning the pieces of extraction information HBB11 to HBB16. For example, the generation unit 1127 generates the first classifier DN11 by learning extraction information extracted based on a response manual RM and a speech log HL of equal to or greater than a predetermined threshold (e.g., 80,000 or more). FIG. 10(B) illustrates one example of annotation imparting performed by the first classifier. For example, the imparting unit 1126 imparts an annotation of a speech intention output by using any speech buffer HB21 as input information to the speech buffer HB21 via the first classifier. Note that the speech buffer HB21 includes user speeches UHL111 to UHL113 of a user U12. Furthermore, for learning of the first classifier, the extraction unit 1128 may add a combination of the speech buffer HB21 and the speech intention output via the first classifier to teacher data used for learning as new extraction information HBB21.

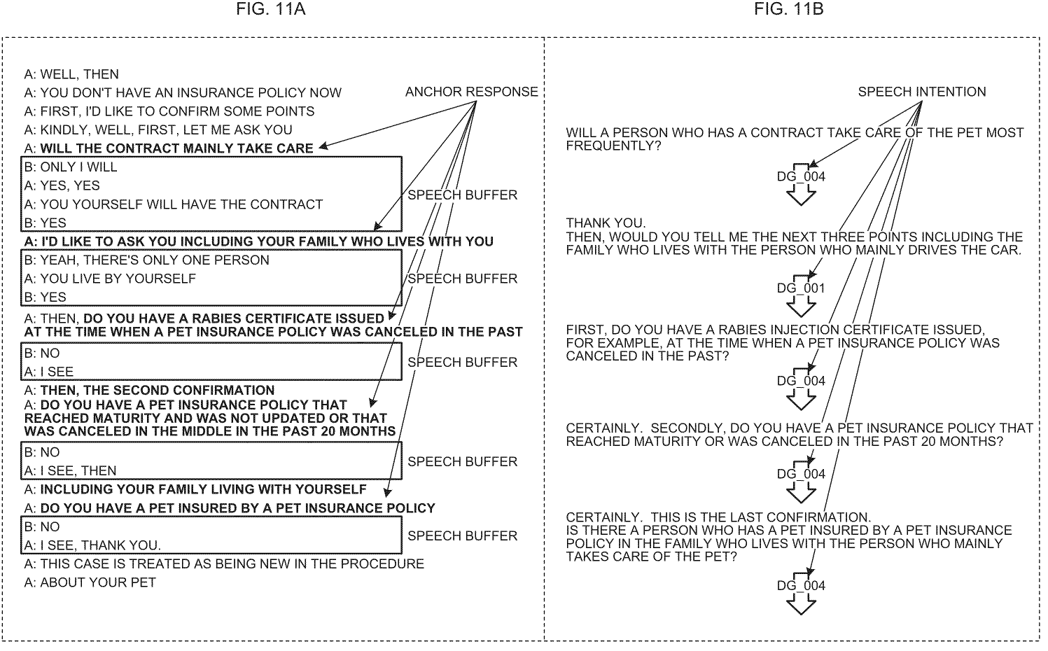

FIG. 11 illustrates one example of the speech log HL and the response manual RM, which include specific text information. FIG. 11(A) illustrates one example of the speech log HL. FIG. 11(A) illustrates a speech buffer and an anchor response together with specific speech logs of an operator and a user. FIG. 11(B) illustrates one example of the response manual RM. FIG. 11(B) illustrates a speech intention of the user together with a specifically described response manual.

### • Extraction Unit 1128

The extraction unit 1128 has a function of extracting information regarding a combination of a speech buffer and a speech intention. Specifically, the extraction unit 1128 extracts information regarding a combination of a speech buffer and a speech intention via the first classifier generated by the generation unit 1127.

The extraction unit 1128 extracts information for generating the second classifier that estimates a speech intention based on the speech log and the response manual acquired by the acquisition unit 111.

### • Output Unit 113

The output unit 113 has a function of outputting information regarding a combination of a speech buffer and a speech intention extracted by the extraction unit 1128. The output unit 113 provides the extraction information extracted by the extraction unit 1128 to, for example, the speech intention estimating apparatus 30 via the communication unit 100. In other words, the output unit 113 provides information for generating the second classifier by learning to the speech intention estimating apparatus 30.

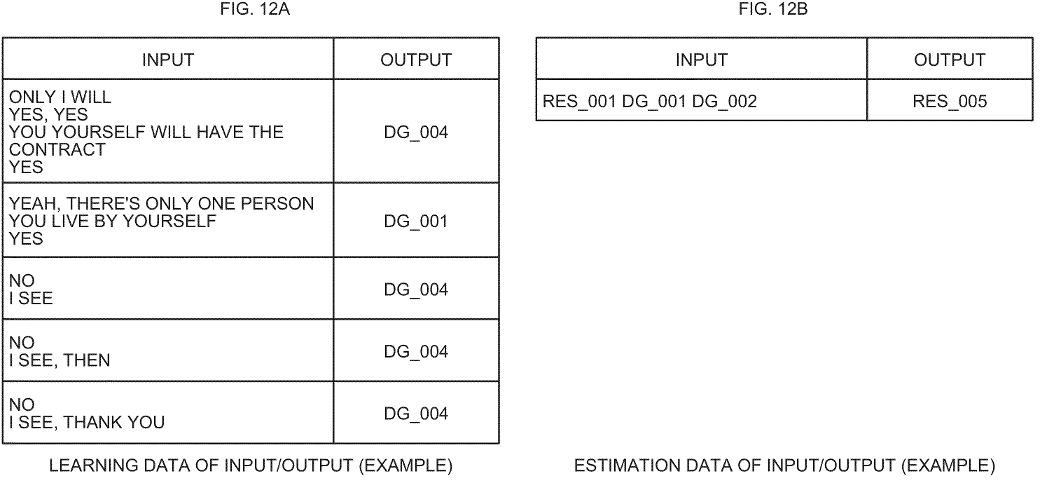

FIG. 12 illustrates one example of output information provided by the output unit 113. FIG. 12(A) illustrates one example of teacher data used for learning of the second classifier. For example, a generation unit 3121 to be described later generates a second classifier by inputting and learning a pair of a speech buffer (input) and a speech intention (output) included in teacher data LD11. FIG. 12(B) illustrates one example of input information (input data) input at the time when the second classifier is used for estimation and output information (output data) output as an estimation result obtained by the data input.

### 3) Storage Unit 120

The storage unit 120 is implemented by, for example, a semiconductor memory element, such as a random access memory (RAM) and a flash memory, or a storage apparatus, such as a hard disk and an optical disk. The storage unit 120 has a function of storing a computer program and data (including one form of program) regarding processing in the information processing apparatus 10.

FIG. 13 illustrates one example of the storage unit 120. The storage unit 120 in FIG. 13 stores information regarding the first classifier. As illustrated in FIG. 13, the storage unit 120 may include items such as a “first classifier ID” and a “first classifier”.

The “first classifier ID” indicates identification information for identifying the first classifier. The “first classifier” indicates the first classifier. Although, in the example in FIG. 13, conceptual information such as a “first classifier #11” and a “first classifier #12” is stored in the “first classifier”, actually, a weight of a function of the first classifier and the like are stored.

### Speech Information Providing Apparatus 20

As illustrated in FIG. 5, the speech information providing apparatus 20 includes a communication unit 200, a control unit 210, and a storage unit 220.

### 1) Communication Unit 200

The communication unit 200 has a function of communicating with an external apparatus. For example, in the communication with the external apparatus, the communication unit 200 outputs information received from the external apparatus to the control unit 210. Specifically, the communication unit 200 outputs information received from the information processing apparatus 10 to the control unit 210. For example, the communication unit 200 outputs information regarding acquisition of information regarding speech information to the control unit 210.

### 2) Control Unit 210

The control unit 210 has a function of controlling the operation of the speech information providing apparatus 20. For example, the control unit 210 transmits information regarding speech information to the information processing apparatus 10 via the communication unit 200. For example, the control unit 210 transmits information regarding speech information acquired by accessing the storage unit 220 to the information processing apparatus 10. Note that the control unit 210 may include a processor such as a CPU. The control unit 210 may execute processing by performing reading from the storage unit 220. The storage unit 220 stores a computer program that implements a function of transmitting information regarding speech information acquired by accessing the storage unit 220 to the information processing apparatus 10. The control unit 210 may include dedicated hardware.

### 3) Storage Unit 220

The storage unit 220 is implemented by, for example, a semiconductor memory element, such as a RAM and a flash memory, or a storage apparatus, such as a hard disk and an optical disk. The storage unit 220 has a function of storing data regarding processing in the speech information providing apparatus 20.

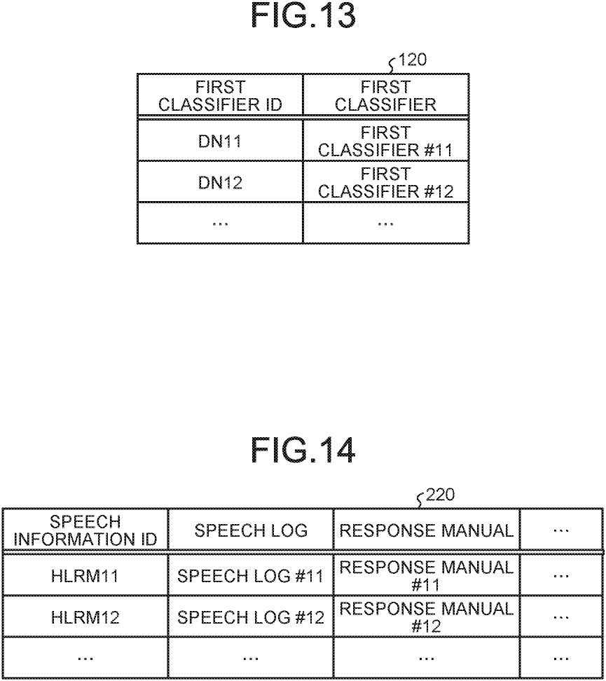

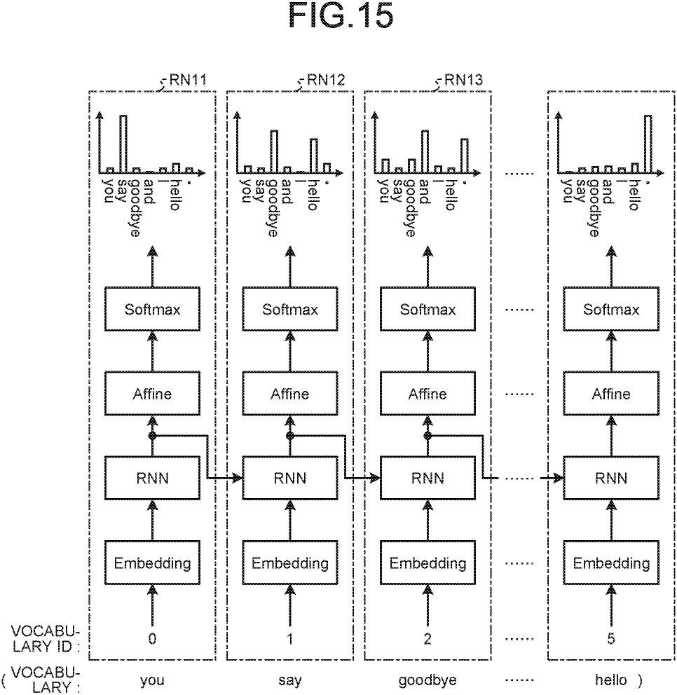

FIG. 14 illustrates one example of the storage unit 220. The storage unit 220 in FIG. 14 stores information regarding speech information. As illustrated in FIG. 14, the storage unit 220 may include items such as a “speech information ID”, a “speech log”, and a “response manual”.

The “speech information ID” indicates identification information for identifying speech information. The “speech log” indicates a speech log. Although, in the example in FIG. 14, conceptual information such as a “speech log #11” and a “speech log #12” is stored in the “speech log”, actually, text information is stored. For example, the “speech log” stores text information of a speech log included in the speech log HL1. The “response manual” indicates a response manual. Although, in the example in FIG. 14, conceptual information such as a “response manual #11” and a “response manual #12” is stored in the “response manual”, actually, text information is stored. For example, the “response manual” stores text information of a response example included in the response manual RM1.

### Speech Intention Estimating Apparatus 30

As illustrated in FIG. 5, the speech intention estimating apparatus 30 includes a communication unit 300, a control unit 310, and a storage unit 320.

### 1) Communication Unit 300

The communication unit 300 has a function of communicating with an external apparatus. For example, in the communication with the external apparatus, the communication unit 300 outputs information received from the external apparatus to the control unit 310. Specifically, the communication unit 300 outputs information received from the information processing apparatus 10 to the control unit 310. For example, the communication unit 300 outputs information for generating the second classifier to the control unit 310.

In the communication with the external apparatus, the communication unit 300 transmits information input from the control unit 310 to the external apparatus. Specifically, the communication unit 300 transmits information regarding acquisition of information for generating the second classifier input from the control unit 310 to the information processing apparatus 10.

### 2) Control Unit 310

The control unit 310 has a function of controlling the operation of the speech intention estimating apparatus 30. For example, the control unit 310 performs processing for estimating a speech intention.

In order to implement the above-described functions, the control unit 310 includes an acquisition unit 311, a processing unit 312, and an output unit 313 as illustrated in FIG. 5. Note that the control unit 310 may include a processor such as a CPU. The control unit 310 may execute processing by performing reading from the storage unit 320. The storage unit 320 stores a computer program that implements each of the functions of the acquisition unit 311, the processing unit 312, and the output unit 313. The control unit 310 may include dedicated hardware.

### • Acquisition Unit 311

The acquisition unit 311 has a function of acquiring information for generating the second classifier. For example, the acquisition unit 311 acquires information transmitted from the information processing apparatus 10 via the communication unit 300. Specifically, the acquisition unit 311 acquires information regarding a combination of a speech buffer and a speech intention.

For example, the acquisition unit 311 acquires any speech log. For example, the acquisition unit 311 acquires a speech log whose speech intention is to be estimated.

### • Processing Unit 312

The processing unit 312 has a function for controlling processing of the speech intention estimating apparatus 30. As illustrated in FIG. 5, the processing unit 312 includes the generation unit 3121 and an estimation unit 3122.

### • Generation Unit 3121

The generation unit 3121 has a function of generating the second classifier that estimates a speech intention. When any speech log is input, the generation unit 3121 generates the second classifier that estimates a speech intention of a user speech included in a speech log. Specifically, the generation unit 3121 generates the second classifier by inputting and learning information regarding the combination of the speech buffer and the speech intention acquired by the acquisition unit 311 as teacher data.

### • Estimation Unit 3122

The estimation unit 3122 has a function of estimating a speech intention via the second classifier generated by the generation unit 3121.

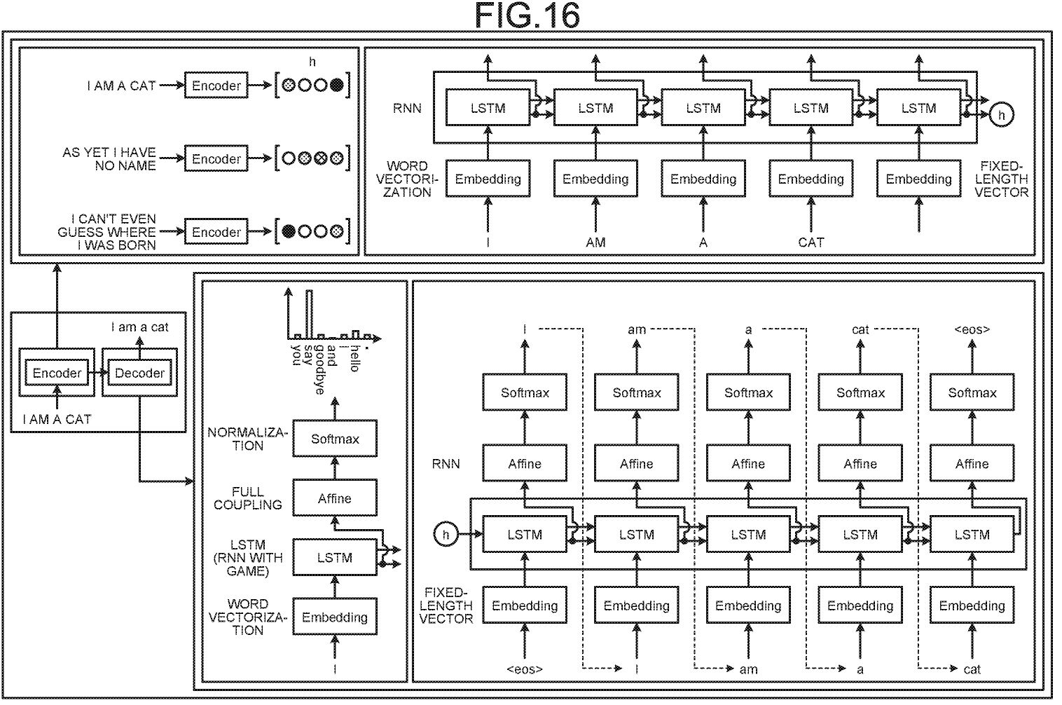

FIG. 15 illustrates one example of processing of estimating a speech intention in a case where an RNN is used as a technique of machine learning of a classifier according to the embodiment. Here, a case where, for example, “you say goodbye and I say hello” is estimated as a speech intention will be described. When “you” is input to the classifier according to the embodiment, text information that appears next to “you” is estimated via processing RN11. In FIG. 15, “say” is estimated as the next vocabulary of “you” by using softmax that can determine a one-hot vector. Note that “Embedding” in the figure is used for converting (e.g., vectorizing) vocabulary into a feature amount. “Affine” in the figure is used for full coupling. “Softmax” in the figure is used for normalization. Next, with the estimated “say” as an input, “goodbye” is estimated as vocabulary next to “say” via processing RN12. Similarly, the speech intention is estimated by estimating the entire vocabulary up to “hello”.

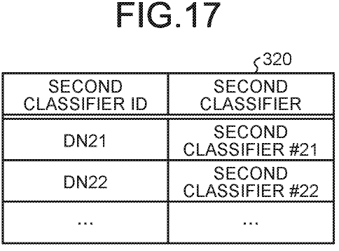

FIG. 16 illustrates a case of using a Seq2seq model obtained by combining two types of RNNs. Specifically, a case where an RNN for an encoder and an RNN for a decoder are combined is illustrated. For example, when “I am a cat” is input to the RNN for an encoder, the text information is encoded into a fixed-length vector (represented by “h” in figure). Furthermore, for example, the encoded fixed-length vector is decoded via the RNN for a decoder. Specifically, “I am a cat” is output.

### • Output Unit 313

The output unit 313 has a function of outputting information regarding a speech intention estimated by the estimation unit 3122. For example, the output unit 313 provides information regarding an estimation result from the estimation unit 3122 to a terminal apparatus used by the operator via the communication unit 300.

### 3) Storage Unit 320

The storage unit 320 is implemented by, for example, a semiconductor memory element, such as a RAM and a flash memory, or a storage apparatus, such as a hard disk and an optical disk. The storage unit 320 has a function of storing data regarding processing in the speech intention estimating apparatus 30.

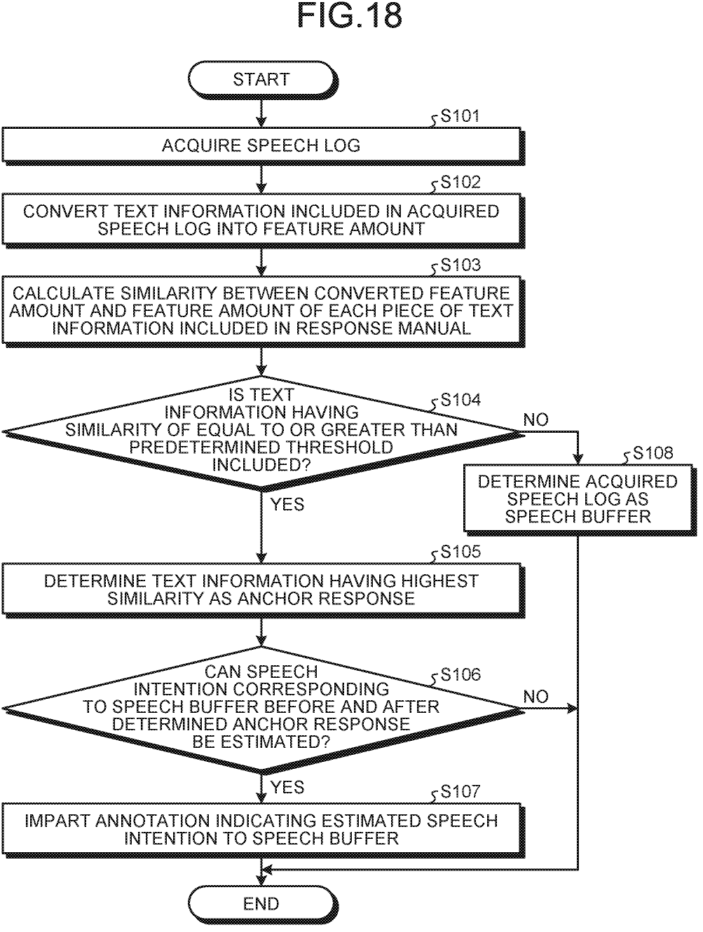

FIG. 17 illustrates one example of the storage unit 320. The storage unit 320 in FIG. 17 stores information regarding the second classifier. As illustrated in FIG. 17, the storage unit 320 may include items such as a “second classifier ID” and a “second classifier”.

The “second classifier ID” indicates identification information for identifying the second classifier. The “second classifier” indicates the second classifier. Although, in the example in FIG. 17, conceptual information such as a “second classifier #21” and a “second classifier #22” is stored in the “second classifier”, actually, a weight of a function of the second classifier and the like are stored.

### <2.3. Processing of Information Processing System>

The function of the information processing system 1 according to the embodiment has been described above. Subsequently, processing of the information processing system 1 will be described.

### (1) Processing in Information Processing Apparatus 10: Annotation Imparting

FIG. 18 is a flowchart illustrating the flow of processing in the information processing apparatus 10 according to the embodiment. First, the information processing apparatus 10 acquires a speech log (S101). Next, the information processing apparatus 10 converts text information included in the acquired speech log into a feature amount (S102). For example, the information processing apparatus 10 converts the text information into vector information. Next, the information processing apparatus 10 calculates the similarity between the converted feature amount and the feature amount of each piece of text information included in a response manual (S103). Then, the information processing apparatus 10 determines whether or not the response manual includes text information having a similarity of equal to or greater than a predetermined threshold (S104). When determining that the response manual includes text information having a similarity of equal to or greater than a predetermined threshold (S104; YES), the information processing apparatus 10 determines text information having the highest similarity as an anchor response (S105). Then, the information processing apparatus 10 determines whether or not a speech intention corresponding to a speech buffer before and after the determined anchor response can be estimated (S106). When determining that the speech intention corresponding to a speech buffer before and after the determined anchor response can be estimated (S106; YES), the information processing apparatus 10 imparts an annotation indicating the estimated speech intention to the speech buffer (S107).

When determining in Step S104 that the response manual does not include text information having a similarity of equal to or greater than a predetermined threshold (S104; NO), the information processing apparatus 10 determines the acquired speech log as a speech buffer (S108). Furthermore, when determining in Step S106 that the speech intention corresponding to a speech buffer before and after the determined anchor response cannot be estimated (S106; NO), the information processing apparatus 10 ends the information processing.

### Processing 1 in Speech Intention Estimating Apparatus 30: Learning

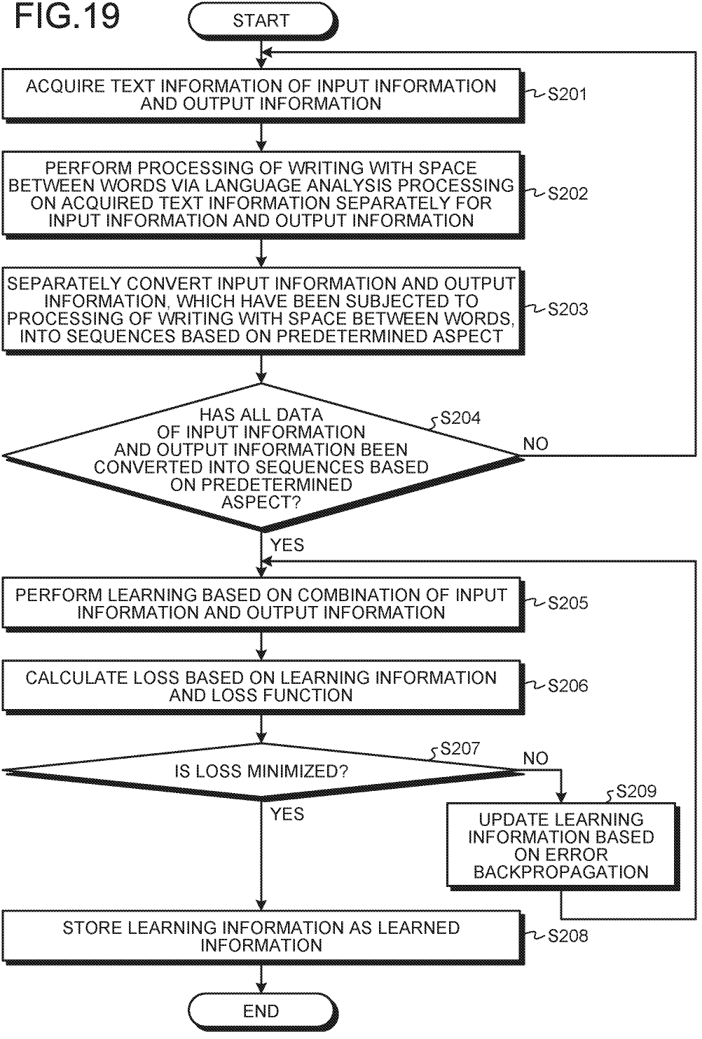

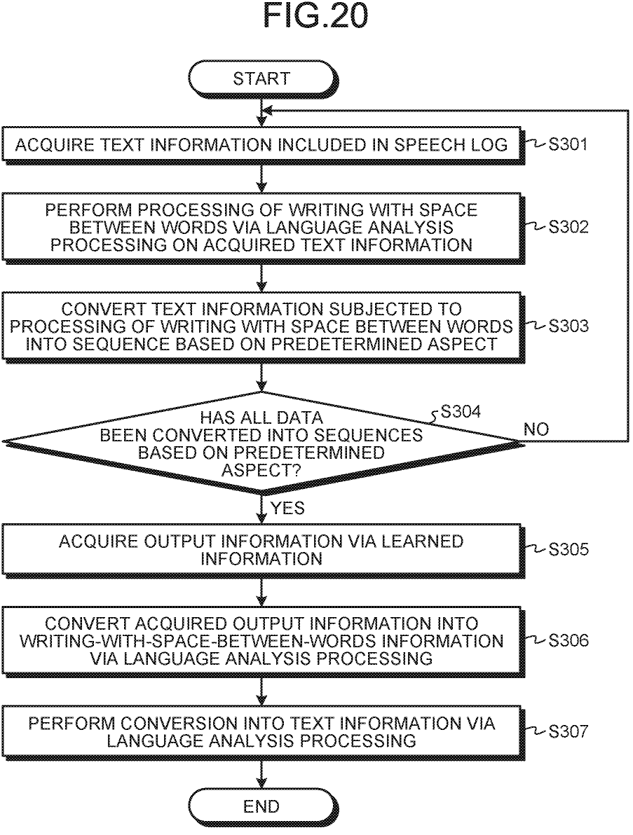

FIG. 19 is a flowchart illustrating the flow of learning processing in the speech intention estimating apparatus 30 according to the embodiment. Specifically, the flow of the learning processing is illustrated. In the learning processing, the speech intention estimating apparatus 30 performs language analysis processing on a speech buffer to vectorize text information included in the speech buffer. A parameter (model parameter) of the second classifier is optimized by using the vectorized information as input information and using error backpropagation so that the losses of output information output via the second classifier and a speech intention included in teacher data are minimized.

First, the speech intention estimating apparatus 30 acquires text information of input information and output information (S201). Next, the speech intention estimating apparatus 30 performs processing of writing with space between words via language analysis processing (e.g., vocabulary dictionary) on the acquired text information separately for the input information and the output information (S202). Next, the speech intention estimating apparatus 30 separately converts the input information and the output information, which have been subjected to the processing of writing with space between words, into sequences based on a predetermined aspect (S203). For example, the speech intention estimating apparatus 30 performs conversion into a sequence based on the vocabulary dictionary. Then, the speech intention estimating apparatus 30 determines whether or not all the data of the input information and the output information has been converted into sequences based on a predetermined aspect (S204). When determining that all the data of the input information and the output information has been converted into sequences based on a predetermined aspect (S204; YES), the speech intention estimating apparatus 30 performs learning processing based on a combination of the input information and the output information (S205). For example, the speech intention estimating apparatus 30 learns information regarding a model parameter of the second classifier. In this case, the speech intention estimating apparatus 30 may cause 80% of the combination of the input information and the output information to be learned as learning data, for example. Then, the speech intention estimating apparatus 30 calculates a loss via a loss function based on learning information and the combination of the input information and the output information (S206). In this case, the speech intention estimating apparatus 30 may calculate the loss by using 20% of the remaining combination of the input information and the output information as verification data. Then, the speech intention estimating apparatus 30 determines whether or not the calculated loss is minimized (S207). When determining that the calculated loss is minimized (S207; YES), the speech intention estimating apparatus 30 stores the learning information as learned information (S208) .

When determining in Step S204 that all the data of the input information and the output information has not been converted into sequences based on a predetermined aspect (S204; NO), the speech intention estimating apparatus 30 returns to the processing of Step S201. Furthermore, when determining in Step S207 that the calculated loss is not minimized (S207; NO), the speech intention estimating apparatus 30 updates the learning information based on the error backpropagation (S209). Then, the speech intention estimating apparatus 30 returns to the processing of Step S205.

### Processing 2 in Speech Intention Estimating Apparatus 30: Estimation

FIG. 20 is a flowchart illustrating the flow of processing in the speech intention estimating apparatus 30 according to the embodiment. Specifically, the flow of processing in which the speech intention estimating apparatus 30 estimates a speech intention from an actual speech log by using the learning information learned in FIG. 19 is illustrated.

First, the speech intention estimating apparatus 30 acquires text information included in a speech log (S301). Next, the speech intention estimating apparatus 30 performs processing of writing with space between words via language analysis processing on the acquired text information (S302). Next, the speech intention estimating apparatus 30 converts the text information subjected to the processing of writing with space between words into a sequence based on a predetermined aspect (S303). Then, the speech intention estimating apparatus 30 determines whether or not all the data of the text information included in the speech log has been converted into sequences based on the predetermined aspect (S304). When determining that all the data has been converted into sequences based on the predetermined aspect (S304; YES), the speech intention estimating apparatus 30 acquires output information via the learned information (S305). Then, the speech intention estimating apparatus 30 converts the acquired output information into writing-with-space-between-words information (e.g., writing-with-space-between-words sentence) via the language analysis processing (S306). Then, the speech intention estimating apparatus 30 converts the writing-with-space-between-words information into text information (e.g., sentence) via the language analysis processing (S307). When determining in Step S304 that all the data has not been converted into sequences based on the predetermined aspect (S304; NO), the speech intention estimating apparatus 30 returns to the processing of Step S301.

### <2.4. Variations of Processing>

The embodiment of the present disclosure has been described above. Subsequently, variations of processing of the embodiment of the present disclosure will be described. Note that the variations of the processing to be described below may be applied to the embodiment of the present disclosure alone, or may be applied to the embodiment of the present disclosure in combination. Furthermore, the variations of the processing may be applied instead of the configuration described in the embodiment of the present disclosure, or may be additionally applied to the configuration described in the embodiment of the present disclosure.

### (1) Identification of Speech Log Corresponding to Response Manual

In the above-described embodiment, a case where the information processing apparatus 10 acquires a speech log from the speech information providing apparatus 20 via the communication unit 100 has been described. The information processing apparatus 10 may generate a classifier DN41 (hereinafter, appropriately referred to as “third classifier”) that has learned identification information of a response manual (e.g., response manual ID) and text information included in the response manual by imparting the identification information to the response manual. Specifically, when any speech log is input, the information processing apparatus 10 may generate the classifier DN41 that estimates which response manual the speech log has referred to. The information processing apparatus 10 may estimate the identification information of the corresponding response manual based on text information of an operator speech included in any speech log via the classifier DN41.

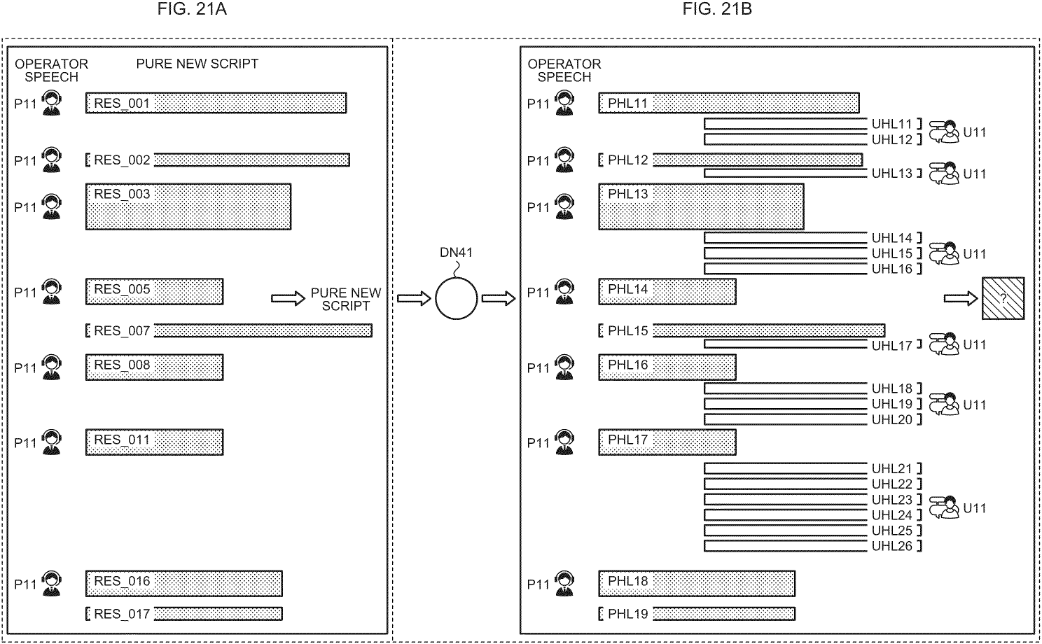

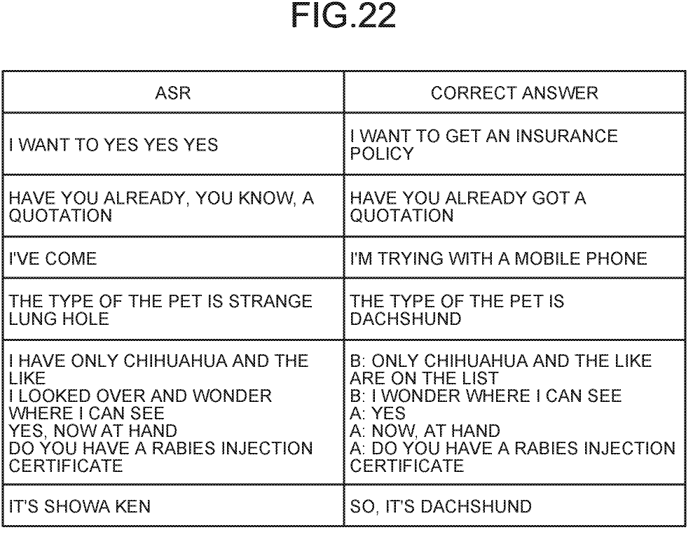

FIG. 21 illustrates one example of the function related to the variations of processing. In the example in FIG. 21, the information processing apparatus 10 imparts “pure new scripts”, which are identification information of response manuals, to the manuals RES001 to RES017. Then, the information processing apparatus 10 generates the classifier DN41 that has learned the manuals RES001 to RES017 and response manual IDs of the “pure new scripts”. Then, the information processing apparatus 10 estimates which response manual the speech log has referred to by using a speech log including the operator speeches PHL11 to PHL19 and the user speeches UHL11 to UHL26 as input information.

### Acquisition of Text Information Via ASR

In the above-described embodiment, the information processing apparatus 10 may acquire text information of a speech log written via the ASR. In Step S101 in FIG. 18, the information processing apparatus 10 may acquire, for example, a speech log based on an ASR result.

FIG. 22 illustrates one example of the ASR result. In the ASR, since noise of a speech cannot be corrected, text information cannot be clearly cut out. As illustrated in FIG. 22, the information processing apparatus 10 acquires an ASR result including an error as a language. This occurs in, for example, a case where a user does not speak smoothly, a case where the user has an accent, a case where the user uses incorrect honorifics, and a case where a speech of the user includes a damage insurance unique expression. In a specific example, the information processing apparatus 10 acquires text information whose original speech is “I want to get an insurance policy” as “I want to yes yes yes” due to an inaccurate way of speaking of the user.

### Estimation of Operator Speech

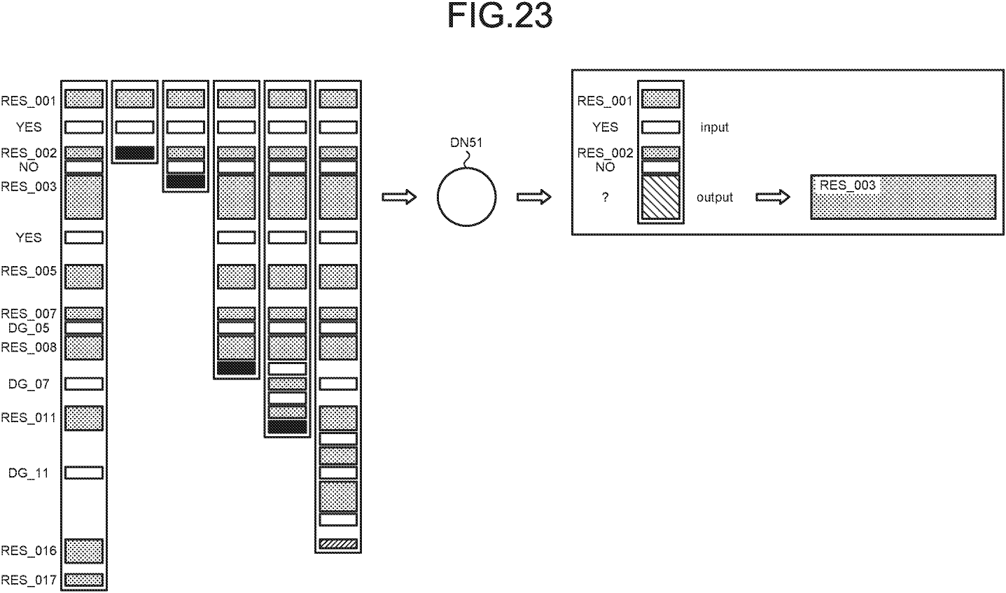

As illustrated in FIG. 23, the information processing apparatus 10 may generate a classifier DN51 that estimates an operator response to be given next by an operator by learning a combination of a plurality of response manuals. Specifically, the information processing apparatus 10 may generate the classifier DN51 by learning a combination of a sequence (flow) of a speech intention and a line of an operator as teacher data. This allows the information processing apparatus 10 to estimate a likely operator response from the entire sequence even in a case of a sequence not included in the teacher data.

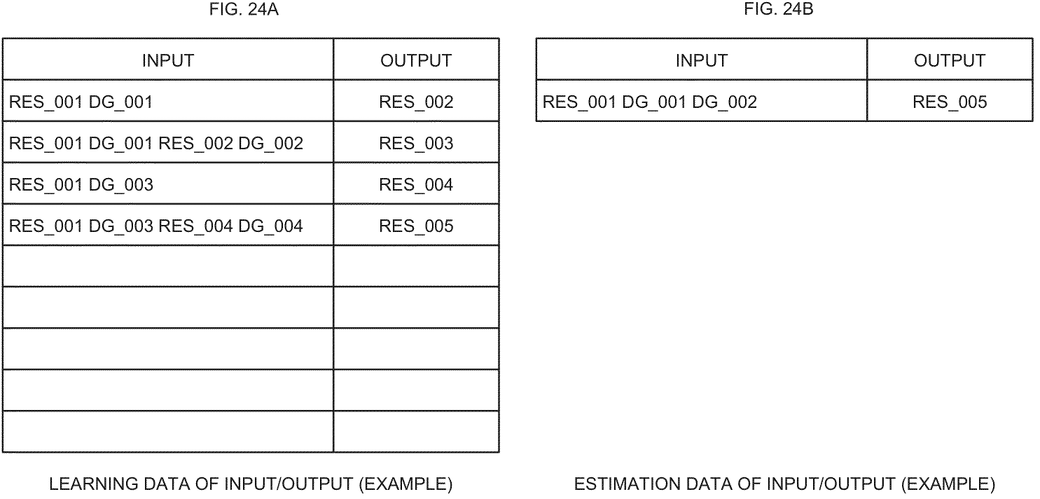

FIG. 24(A) illustrates one example of a combination of an input data sequence used as teacher data at the time when the classifier DN51 is generated by learning and output data indicating a line of the operator. For example, the information processing apparatus 10 generates the classifier DN51 by inputting and learning the data set in FIG. 24(A). FIG. 24(B) illustrates one example of input information (input data sequence) input at the time when the generated classifier DN51 is used for estimation and output information output as an estimation result obtained by the data input.

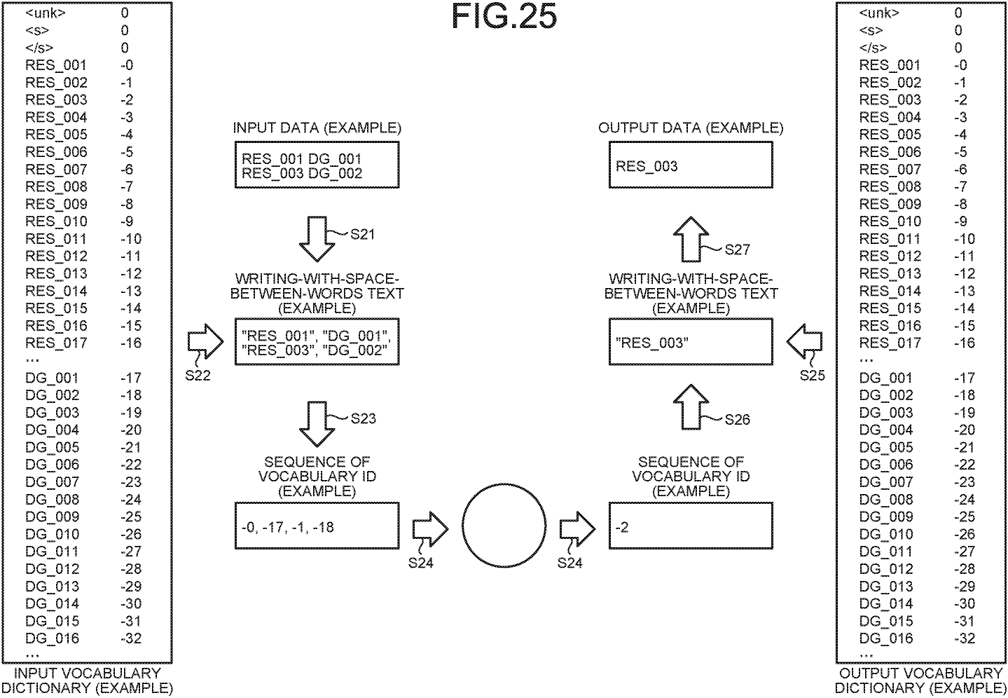

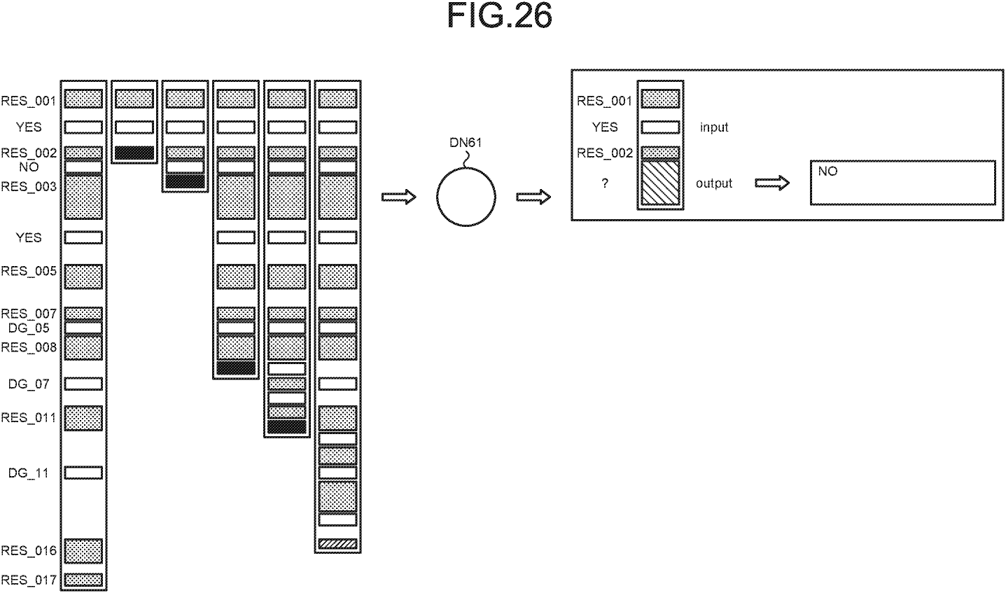

FIG. 25 illustrates one example of estimation processing using the classifier DN51. The information processing apparatus 10 acquires input information. Next, the information processing apparatus 10 converts the acquired input information into writing-with-space-between-words text information (S21). Next, the information processing apparatus 10 uses language analysis information such as a vocabulary dictionary (S22), and performs conversion into the writing-with-space-between-words text information and a sequence (S23). Next, the information processing apparatus 10 acquires output information by inputting the sequence via the classifier DN51 (S24). Next, the information processing apparatus 10 uses the language analysis information such as a vocabulary dictionary (S25), and converts the acquired output information into the writing-with-space-between-words text information (S26). Next, the information processing apparatus 10 converts the writing-with-space-between-words text information into text information (S27).

### Estimation of User Speech

As illustrated in FIG. 26, the information processing apparatus 10 may generate a classifier DN61 that estimates a user response to be given next by the user by inputting and learning a combination of a plurality of response manuals. Specifically, the information processing apparatus 10 may generate the classifier DN61 by inputting and learning a combination of a sequence (flow) of a speech intention and a line of an operator as teacher data. This allows the information processing apparatus 10 to estimate a likely user response from the entire sequence even in a case of a sequence not included in the teacher data.

### User Response Using Emotional Expression

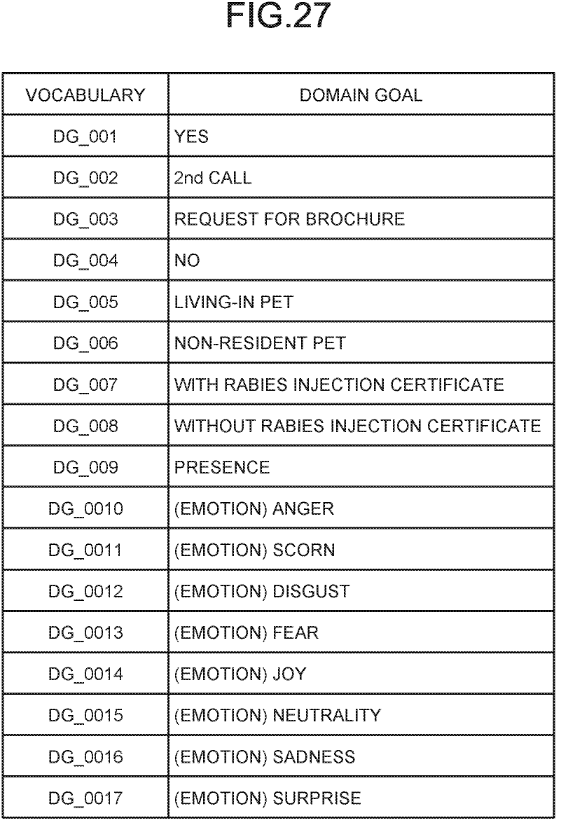

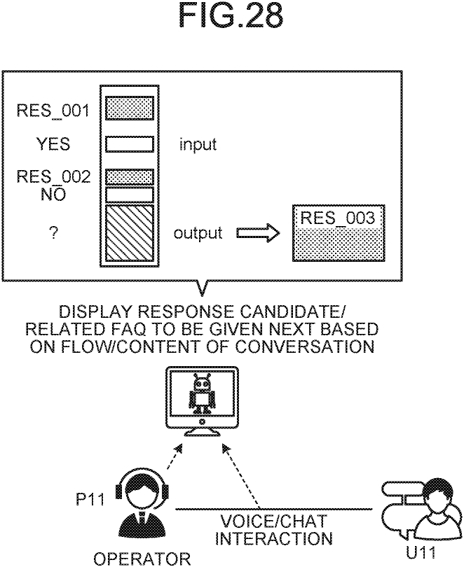

In the above-described embodiment, a case where the user response DG is an example of a user response to a line of the operator or a speech intention has been described. The user response DG may be an emotional expression indicating the emotion of the user. FIG. 27 illustrates one example of the user response DG. User responses DG10 to DG17 are emotional expressions indicating anger, scorn, disgust, fear, joy, neutrality, sadness, and surprise, respectively.

### 3. Applications

The embodiment of the present disclosure has been described above. Subsequently, an application of the information processing system 1 according to the embodiment of the present disclosure will be described.

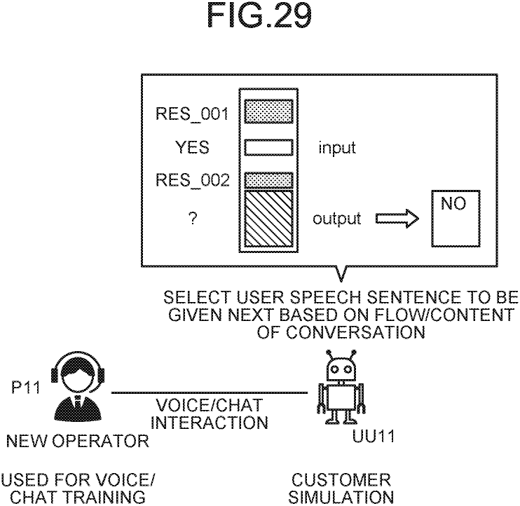

FIG. 28 illustrates a case where the information processing apparatus 10 acquires voice speeches of the operator P11 and the user U11 or chat speeches (dialogues) and displays a response candidate to be given next and related frequently asked questions (FAQ) based on the flow of the speeches or the content thereof.

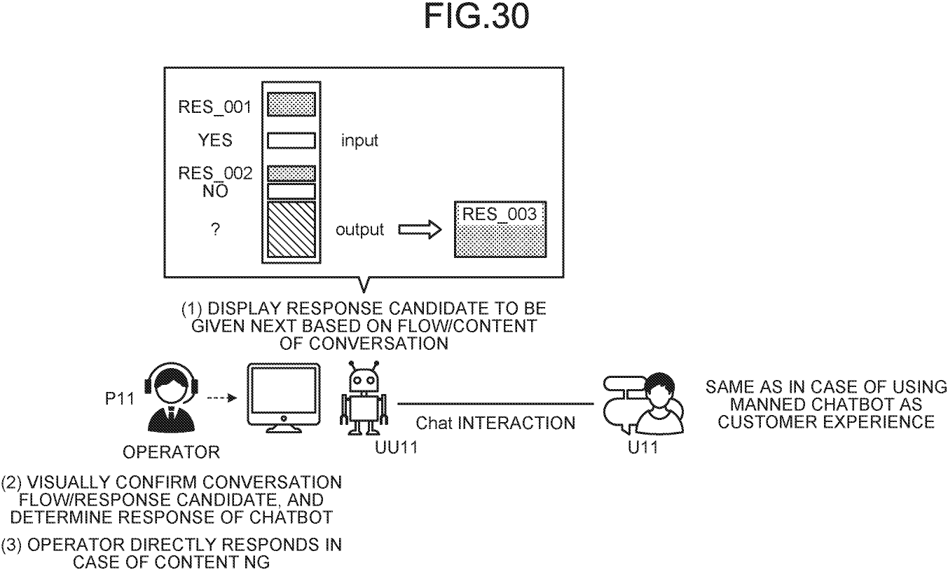

FIG. 29 illustrates a case where the information processing apparatus 10 acquires voice speeches of the operator P11 and a chatbot UU11, which is a simulation tool for speeches with a customer (user), or a chat speech (dialogue), and identifies a user speech to be given next by the user based on the flow of the speeches or the content thereof. This allows the information processing apparatus 10 to promote improvement of speech training for a new operator, for example.

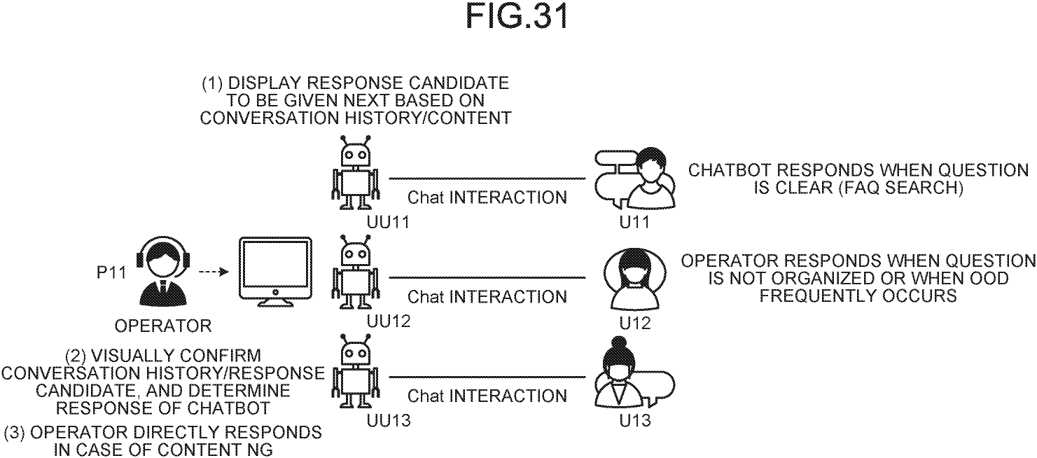

FIG. 30 illustrates a case where the information processing apparatus 10 acquires a chat between the chatbot UU11 and the user U11 and displays a response candidate to be given next based on the flow of the chat or the content thereof, and the operator P11 confirms the flow of the chat and the response candidate and performs processing for determining a response of the chatbot UU11. Furthermore, when the operator P11 denies the response candidate, the information processing apparatus 10 may perform processing for the operator P11 to directly give a response.

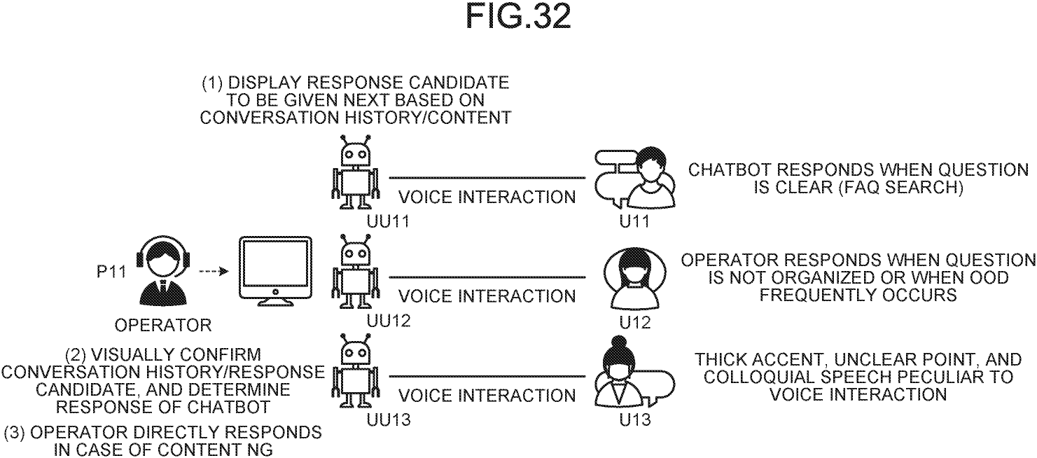

FIG. 31 illustrates a case where the information processing apparatus 10 simultaneously acquires a plurality of chats between the chatbots UU11 to UU13 and the users U11 to U13 and displays each response candidate to be given next based on the flow of each chat or the content thereof, and the operator P11 confirms the flow of each chat and each response candidate and performs processing for determining each of responses of the chatbots UU11 to UU13. Furthermore, when the operator P11 denies any response candidate, the information processing apparatus 10 may perform processing for the operator P11 to directly give a response for the chat instead of the denied response candidate.

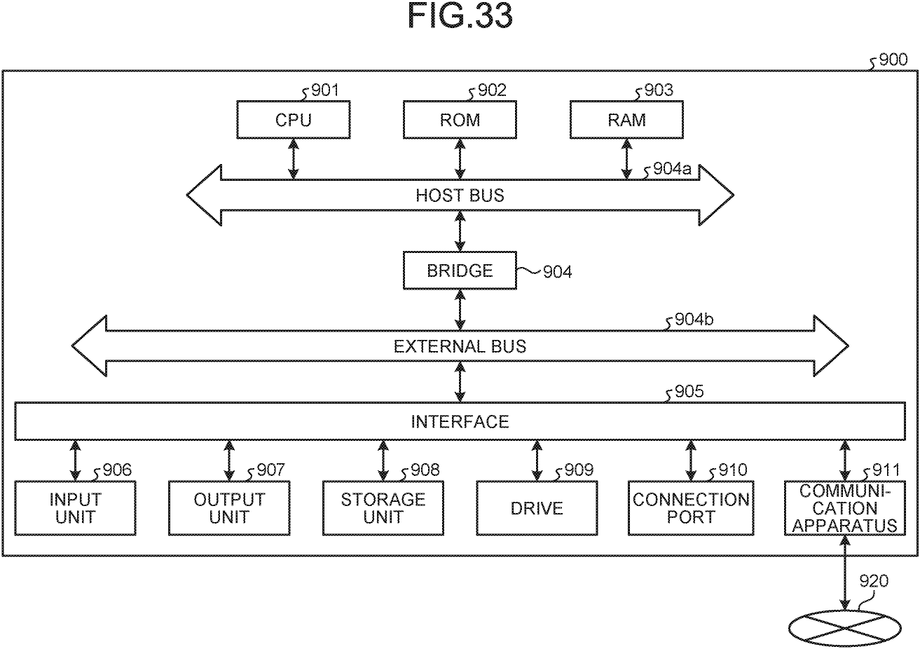

FIG. 32 illustrates a case where the information processing apparatus 10 simultaneously acquires a plurality of voice speeches of the chatbots UU11 to UU13 and the users U11 to U13 and displays each response candidate to be given next based on the flow of each speech or the content thereof, and the operator P11 confirms the flow of each speech and each response candidate and performs processing for determining each of responses of the chatbots UU11 to UU13. Furthermore, when the operator P11 denies any response candidate, the information processing apparatus 10 may perform processing for the operator P11 to directly give a response for the speech instead of the denied response candidate.

### 4. Hardware Configuration Example

Finally, a hardware configuration example of the information processing apparatus according to the embodiment will be described with reference to FIG. 33. FIG. 33 is a block diagram illustrating a hardware configuration example of the information processing apparatus according to the embodiment. Note that an information processing apparatus 900 in FIG. 33 can implement, for example, the information processing apparatus 10, the speech information providing apparatus 20, and the speech intention estimating apparatus 30 in FIG. 5. Information processing performed by the information processing apparatus 10, the speech information providing apparatus 20, and the speech intention estimating apparatus 30 according to the embodiment is achieved by cooperation of software (including computer program) and hardware to be described below.

As illustrated in FIG. 33, the information processing apparatus 900 includes a central processing unit (CPU) 901, a read only memory (ROM) 902, and a random access memory (RAM) 903. Furthermore, the information processing apparatus 900 includes a host bus 904a, a bridge 904, an external bus 904b, an interface 905, an input apparatus 906, an output apparatus 907, a storage apparatus 908, a drive 909, a connection port 910, and a communication apparatus 911. Note that the hardware configuration illustrated here is one example, and some of the components may be omitted. Furthermore, the hardware configuration may further include components other than the components illustrated here.

The CPU 901 functions as, for example, an arithmetic processing apparatus or a control apparatus, and controls the overall or part of the operation of each component based on various computer programs recorded in the ROM 902, the RAM 903, or the storage apparatus 908. The ROM 902 is a device that stores a program read by the CPU 901, data used for calculation, and the like. The RAM 903 temporarily or permanently stores, for example, a program read by the CPU 901 and data such as various parameters that appropriately change at the time of execution of the program (part of program). These components are mutually connected by the host bus 904a including a CPU bus and the like. The CPU 901, the ROM 902, and the RAM 903 can implement the functions of the control unit 110, the control unit 210, and the control unit 310 described with reference to FIG. 5 by cooperation with software, for example.

The CPU 901, the ROM 902, and the RAM 903 are mutually connected via, for example, the host bus 904a capable of highspeed data transmission. In contrast, the host bus 904a is connected to the external bus 904b having a relatively low data transmission speed via the bridge 904, for example. Furthermore, the external bus 904b is connected to various components via the interface 905.

The input apparatus 906 is implemented by an apparatus to which information is input by a listener, such as a mouse, a keyboard, a touch panel, a button, a microphone, a switch, and a lever. Furthermore, for example, the input apparatus 906 may be a remote-control apparatus using infrared rays or other radio waves, or may be an external connection device, such as a mobile phone and a PDA, compliant with the operation of the information processing apparatus 900. Moreover, for example, the input apparatus 906 may include an input control circuit and the like, which generates an input signal based on information input by the above-described input devices and outputs the input signal to the CPU 901. A manager of the information processing apparatus 900 can input various pieces of data or give an instruction for processing operation to the information processing apparatus 900 by operating the input apparatus 906.

In addition, the input apparatus 906 can be formed by an apparatus that detects a position of a user. For example, the input apparatus 906 may include various sensors such as an image sensor (e.g., camera), a depth sensor (e.g., stereo camera), an acceleration sensor, a gyro sensor, a geomagnetic sensor, an optical sensor, a sound sensor, a distance measurement sensor (e.g., time of flight (ToF) sensor), and a force sensor. Furthermore, the input apparatus 906 may acquire information on the state of the information processing apparatus 900, such as the posture and moving speed of the information processing apparatus 900, and information on the surrounding space of the information processing apparatus 900, such as brightness and noise around the information processing apparatus 900. Furthermore, the input apparatus 906 may include a global navigation satellite system (GNSS) module that receives a GNSS signal (e.g., global positioning system (GPS) signal from GPS satellite) from a GNSS satellite and measures position information including the latitude, longitude, and altitude of the apparatus. Furthermore, in relation to the position information, the input apparatus 906 may detect a position by Wi-Fi (registered trademark), transmission and reception to and from mobile phone/PHS/smartphone, or near field communication. The input apparatus 906 can implement the function of the acquisition unit 111 described with reference to FIG. 5, for example.

The output apparatus 907 is formed by an apparatus capable of visually or auditorily notifying the user of the acquired information. Examples of such an apparatus include a display apparatus, an acoustic output apparatus, a printer apparatus, and the like. The display apparatus includes a CRT display apparatus, a liquid crystal display apparatus, a plasma display apparatus, an EL display apparatus, a laser projector, an LED projector, a lamp, and the like. The acoustic output apparatus includes a speaker, a headphone, and the like. The output apparatus 907 outputs results obtained by various pieces of processing performed by the information processing apparatus 900, for example. Specifically, the display apparatus visually displays results obtained by various pieces of processing performed by the information processing apparatus 900 in various formats such as text, images, tables, and graphs. In contrast, the voice output apparatus converts an audio signal including data on reproduced voice, acoustic data, and the like into an analog signal, and auditorily outputs the analog signal. The output apparatus 907 can implement the functions of the output unit 113 and the output unit 313 described with reference to FIG. 5, for example.

The storage apparatus 908 is formed as one example of a storage unit of the information processing apparatus 900, and stores data. The storage apparatus 908 is implemented by, for example, a magnetic storage unit device such as an HDD, a semiconductor storage device, an optical storage device, a magneto-optical storage device, or the like. The storage apparatus 908 may include a storage medium, a recording apparatus, a reading apparatus, a deletion apparatus, and the like. The recording apparatus records data in the storage medium. The reading apparatus reads data from the storage medium. The deletion apparatus deletes data recorded in the storage medium. The storage apparatus 908 stores computer programs executed by the CPU 901, various pieces of data, various pieces of data acquired from the outside, and the like. The storage apparatus 908 can achieve the functions of the storage unit 120, the storage unit 220, and the storage unit 320 described with reference to FIG. 5, for example.

The drive 909 is a reader/writer for a storage medium, and is built in or externally attached to the information processing apparatus 900. The drive 909 reads information recorded in a removable storage medium mounted on the drive 909 itself, such as a magnetic disk, an optical disk, a magneto-optical disk, and a semiconductor memory, and outputs the information to the RAM 903. Furthermore, the drive 909 can also write information in the removable storage medium.

The connection port 910 connects an external connection device. The connection port 910 includes, for example, a universal serial bus (USB) port, an IEEE 1394 port, a small computer system interface (SCSI), an RS-232C port, and an optical audio terminal, for example.

The communication apparatus 911 is a communication interface formed by, for example, a communication device for connection with a network 920. The communication apparatus 911 is, for example, a communication card for a wired or wireless local area network (LAN), long term evolution (LTE), Bluetooth (registered trademark), a wireless USB (WUSB), and the like. Furthermore, the communication apparatus 911 may be a router for optical communication, a router for an asymmetric digital subscriber line (ADSL), a modem for various pieces of communication, and the like. For example, the communication apparatus 911 can transmit and receive a signal and the like over the Internet or to and from the Internet and other communication devices in accordance with a predetermined protocol such as TCP/IP. The communication apparatus 911 can implement the functions of the communication unit 100, the communication unit 200, and the communication unit 300 described with reference to FIG. 5, for example.

Note that the network 920 is a wired or wireless transmission path for information transmitted from an apparatus connected to the network 920. For example, the network 920 may include a public network such as the Internet, a telephone network, and a satellite communication network, various local area networks (LANs) including Ethernet (registered trademark), a wide area network (WAN), and the like. Furthermore, the network 920 may include a dedicated network such as an internet protocol-virtual private network (IP-VPN).

One example of the hardware configuration capable of implementing the function of the information processing apparatus 900 according to the embodiment has been described above. Each of the above-described components may be implemented by using a general-purpose member or by hardware specialized for the function of each component. Therefore, the hardware configuration to be used can be appropriately changed in accordance with the technical level at the time of carrying out the embodiment.

### <<5. Conclusion»

As described above, the information processing apparatus 10 according to the embodiment performs processing of extracting information for generating the second classifier that estimates a speech intention of a user. This allows the information processing apparatus 10 to make it easy for an operator to grasp a speech intention of the user, so that more fulfilling service can be provided to the user, for example.

For example, even when a user speech includes noise, the information processing apparatus 10 can estimate a speech buffer based on an operator speech, so that information for appropriately estimating a speech intention can be extracted.

As a result, a new and improved information processing apparatus and information processing method capable of providing more fulfilling service to a user can be provided.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in claims, and it is naturally understood that these changes or modifications also belong to the technical scope of the present disclosure.

For example, each apparatus described in the present specification may be implemented as a single apparatus, or a part or all of the apparatuses may be implemented as separate apparatuses. For example, each of the information processing apparatus 10, the speech information providing apparatus 20, and the speech intention estimating apparatus 30 in FIG. 5 may be implemented as a single apparatus. Furthermore, for example, the information processing apparatus 10, the speech information providing apparatus 20, and the speech intention estimating apparatus 30 may be implemented as a server apparatus connected to each other by a network and the like. Furthermore, the server apparatus connected by a network and the like may have the function of the control unit 110 of the information processing apparatus 10.

Furthermore, the series of processing performed by each apparatus described in the present specification may be performed by using any of software, hardware, and a combination of software and hardware. For example, a recording medium (non-transitory medium) provided inside or outside each apparatus preliminarily stores a computer program constituting software. Then, each program is read into a RAM at the time of execution performed by a computer, and executed by a processor such as a CPU, for example.

Furthermore, the processing described by using the flowcharts in the present specification is not necessarily required to be executed in the illustrated order. Some processing steps may be performed in parallel. Furthermore, an additional processing step may be adopted, or some processing steps may be omitted.

Furthermore, the effects described in the present specification are merely illustrative or exemplary ones, and are not limitations. That is, the technology according to the present disclosure can exhibit other effects obvious to those skilled in the art from the description of the present specification together with or instead of the above-described effects.

Note that the following configurations also belong to the technical scope of the present disclosure.

An information processing apparatus including:
an acquisition unit that acquires speech logs of speeches of a plurality of speakers; and
an extraction unit that extracts information for generating a classifier that estimates a speech intention of each of the speeches based on the speech logs acquired by the acquisition unit and a response manual indicating an example of a response for each of the speeches.

The information processing apparatus according to (1),
wherein the acquisition unit acquires speech logs given by a plurality of speakers including a first speaker and a second speaker, and
the extraction unit extracts information for generating a second classifier that estimates a speech intention of the second speaker based on the speech logs and the response manual for a speech of the first speaker.

The information processing apparatus according to (2),

wherein the extraction unit extracts information for generating the second classifier that estimates a speech intention of the second speaker by using any speech log as input information.

The information processing apparatus according to (3),

wherein the extraction unit extracts teacher data of the second classifier based on a speech intention of the second speaker and a speech log of the second speaker.

The information processing apparatus according to (4), further including
a generation unit that generates a first classifier that extracts a speech log of the second speaker and a corresponding speech intention of the second speaker by using the speech log and the response manual as input information,
wherein the extraction unit extracts the teacher data by using the first classifier generated by the generation unit.

The information processing apparatus according to (5),

wherein the extraction unit extracts the teacher data based on a speech log of the second speaker estimated based on a speech log satisfying a predetermined condition among a speech log of the first speaker as processing performed by the first classifier.

The information processing apparatus according to (6), further including
a calculation unit that calculates a similarity between a feature amount of a speech log of the first speaker and a feature amount of the response manual,
wherein the extraction unit extracts the teacher data based on a speech log of the second speaker estimated based on a speech log of the first speaker identified based on the similarity calculated by the calculation unit.

The information processing apparatus according to any one of (4) to (7),

wherein the extraction unit extracts the teacher data based on a speech intention of the second speaker indicating emotion of the second speaker estimated from a speech log of the second speaker.

The information processing apparatus according to any one of (4) to (8),

wherein the extraction unit extracts teacher data of the second classifier generated by inputting and learning the teacher data.

The information processing apparatus according to (9),

wherein the extraction unit extracts teacher data of the second classifier learned so as to minimize a loss based on a loss function between output information output by inputting a speech log of the second speaker to the second classifier and a speech intention of the second speaker indicated by the teacher data.

The information processing apparatus according to any one of (2) to (10),

wherein the extraction unit extracts information for generating the second classifier that estimates a speech intention of the second speaker based on a response manual estimated by using any speech log as input information and any speech log.

The information processing apparatus according to any one of (2) to (11),

wherein the extraction unit extracts information for generating the second classifier that estimates a speech intention of the second speaker based on the response manual including an example of a response for a speech of the second speaker to an example of a response for a speech of the first speaker.

The information processing apparatus according to any one of (2) to (12),

wherein the acquisition unit acquires speech logs given by the plurality of speakers including an operator corresponding to the first speaker and a user corresponding to the second speaker who uses service operated by the operator.

The information processing apparatus according to any one of (1) to (13),

wherein the acquisition unit acquires text information obtained by writing speeches into text as the speech logs.

An information processing method executed by a computer, including the steps of:
acquiring speech logs of speeches of a plurality of speakers; and
extracting information for generating a classifier that estimates a speech intention of each of the speeches based on the speech logs acquired in the acquiring and a response manual for each of the speeches.

An information processing method executed by a computer, including the steps of:
acquiring speech logs of speeches of a plurality of speakers; and
generating a classifier for estimating a speech intention of each of the speeches based on the speech logs acquired in the acquiring and a response manual indicating an example of a response for each of the speeches.

### Reference Signs List

1 INFORMATION PROCESSING SYSTEM
10 INFORMATION PROCESSING APPARATUS
20 SPEECH INFORMATION PROVIDING APPARATUS
30 SPEECH INTENTION ESTIMATING APPARATUS
100 COMMUNICATION UNIT
110 CONTROL UNIT
111 ACQUISITION UNIT
112 PROCESSING UNIT
1121 CONVERSION UNIT
1122 CALCULATION UNIT
1123 IDENTIFICATION UNIT
1124 DETERMINATION UNIT
1125 ESTIMATION UNIT
1126 IMPARTING UNIT
1127 GENERATION UNIT
1128 EXTRACTION UNIT
113 OUTPUT UNIT
120 STORAGE UNIT
200 COMMUNICATION UNIT
210 CONTROL UNIT
220 STORAGE UNIT
300 COMMUNICATION UNIT
310 CONTROL UNIT
311 ACQUISITION UNIT
312 PROCESSING UNIT
3121 GENERATION UNIT
3122 ESTIMATION UNIT
313 OUTPUT UNIT
320 STORAGE UNIT

1. An information processing apparatus including:
an acquisition unit that acquires speech logs of speeches of a plurality of speakers; and
an extraction unit that extracts information for generating a classifier that estimates a speech intention of each of the speeches based on the speech logs acquired by the acquisition unit and a response manual indicating an example of a response for each of the speeches.

2. The information processing apparatus according to claim 1,
wherein the acquisition unit acquires speech logs given by a plurality of speakers including a first speaker and a second speaker, and
the extraction unit extracts information for generating a second classifier that estimates a speech intention of the second speaker based on the speech logs and the response manual for a speech of the first speaker.

3. The information processing apparatus according to claim 2,
wherein the extraction unit extracts information for generating the second classifier that estimates a speech intention of the second speaker by using any speech log as input information.

4. The information processing apparatus according to claim 3,
wherein the extraction unit extracts teacher data of the second classifier based on a speech intention of the second speaker and a speech log of the second speaker.

5. The information processing apparatus according to claim 4, further including
a generation unit that generates a first classifier that extracts a speech log of the second speaker and a corresponding speech intention of the second speaker by using the speech log and the response manual as input information,
wherein the extraction unit extracts the teacher data by using the first classifier generated by the generation unit.

6. The information processing apparatus according to claim 5,
wherein the extraction unit extracts the teacher data based on a speech log of the second speaker estimated based on a speech log satisfying a predetermined condition among a speech log of the first speaker as processing performed by the first classifier.

7. The information processing apparatus according to claim 6, further including
a calculation unit that calculates a similarity between a feature amount of a speech log of the first speaker and a feature amount of the response manual,
wherein the extraction unit extracts the teacher data based on a speech log of the second speaker estimated based on a speech log of the first speaker identified based on the similarity calculated by the calculation unit.

8. The information processing apparatus according to claim 4,
wherein the extraction unit extracts the teacher data based on a speech intention of the second speaker indicating emotion of the second speaker estimated from a speech log of the second speaker.

9. The information processing apparatus according to claim 4,
wherein the extraction unit extracts teacher data of the second classifier generated by inputting and learning the teacher data.

10. The information processing apparatus according to claim 9,
wherein the extraction unit extracts teacher data of the second classifier learned so as to minimize a loss based on a loss function between output information output by inputting a speech log of the second speaker to the second classifier and a speech intention of the second speaker indicated by the teacher data.

11. The information processing apparatus according to claim 2,
wherein the extraction unit extracts information for generating the second classifier that estimates a speech intention of the second speaker based on a response manual estimated by using any speech log as input information and any speech log.

12. The information processing apparatus according to claim 2,
wherein the extraction unit extracts information for generating the second classifier that estimates a speech intention of the second speaker based on the response manual including an example of a response for a speech of the second speaker to an example of a response for a speech of the first speaker.

13. The information processing apparatus according to claim 2,
wherein the acquisition unit acquires speech logs given by the plurality of speakers including an operator corresponding to the first speaker and a user corresponding to the second speaker who uses service operated by the operator.

14. The information processing apparatus according to claim 1,
wherein the acquisition unit acquires text information obtained by writing speeches into text as the speech logs.

15. An information processing method executed by a computer, including the steps of:
acquiring speech logs of speeches of a plurality of speakers; and
extracting information for generating a classifier that estimates a speech intention of each of the speeches based on the speech logs acquired in the acquiring and a response manual for each of the speeches.

16. An information processing method executed by a computer, including the steps of:
acquiring speech logs of speeches of a plurality of speakers; and
generating a classifier for estimating a speech intention of each of the speeches based on the speech logs acquired in the acquiring and a response manual indicating an example of a response for each of the speeches.
